(19) United States
(12) Patent Application Publication
(10) Pub. No.: US 2015/0356501 A1
(43) Pub. Date: Dec. 10, 2015

(54) DELIVERY TO MOBILE DEVICES

(71) Applicant: Clowd Lab LLC, Rosemount, MN (US)

(72) Inventors: Alec Gorjestani, Rosemount, MN (US); Arvind Menon, Minneapolis, MN (US); Edmund Arpin, St. Paul, MN (US)

(21) Appl. No.: 14/726,483

(22) Filed: May 30, 2015

Related U.S. Application Data
(60) Provisional application No. 62/009,576, filed on Jun. 9, 2014.

(51) Int. Cl. G06Q 10/08; H04W 4/02

(52) U.S. Cl. CPC G06Q 10/0833; H04W 4/02

(57) ABSTRACT

In one implementation, a computer-implemented method includes receiving, at a mobile computing device and after transmitting an order, information that identifies a delivery worker who is handling delivery of the order; continuously updating an interface presented by the mobile computing device until the order has been delivered, the interface identifying a current location of the delivery worker relative to a current location of the mobile computing device as both of the current locations change over time, the continuously updating including: determining, by the mobile computing device, the current location of the mobile computing device; receiving, at the mobile computing device, the current location of the delivery worker; and presenting, by the mobile computing device, the interface depicting the current location of the delivery worker relative to the current location of the mobile computing device.

### CROSS-REFERENCE TO RELATED APPLICATIONS

This application claims the benefit of U.S. Provisional Application No. 62/009,576, entitled “DELIVERY TO MOBILE DEVICES,” which was filed on Jun. 9, 2014, the entire contents of which are incorporated by reference herein.

### TECHNICAL FIELD

This document generally describes computer-based technology for facilitating the delivery of items, such as goods and/or services, to users of mobile computing devices.

### BACKGROUND

Mobile computing devices, such as smartphones, tablet computing devices, and cell phones, have been used to order goods and services from vendors. For example, mobile applications (mobile apps) for mobile computing devices have been developed for users to order food items in advance for pickup at a later time.

### SUMMARY

This document generally describes technology for facilitating the ordering and/or delivery of items (e.g., goods, services) to users of mobile computing devices (e.g., smartphones, tablet computing devices, devices embedded within mobile units/vehicles (e.g., devices embedded within golf carts, cars, trucks)). For example, the computer-based technology described in this document can allow a golfer to use his/her mobile computing device to place an order for items, such as food and beverages, while on the golf course and to facilitate the delivery of such items to the golfer, who may move to a different location after placing the order, by a mobile delivery unit (e.g., worker driving a beverage/food cart at the golf course).

In one implementation, a computer-implemented method includes receiving, at a mobile computing device and after transmitting an order, information that identifies a delivery worker who is handling delivery of the order; continuously updating an interface presented by the mobile computing device until the order has been delivered, the interface identifying a current location of the delivery worker relative to a current location of the mobile computing device as both of the current locations change over time, the continuously updating including: determining, by the mobile computing device, the current location of the mobile computing device; receiving, at the mobile computing device, the current location of the delivery worker; and presenting, by the mobile computing device, the interface depicting the current location of the delivery worker relative to the current location of the mobile computing device.

In another implementation, a computer-implemented method includes accessing, by a computer system, historical order information that describes locations at which orders were placed across a particular geographic area; identifying, by the computer system based, at least in part, on the historical order information, one or more locations within the particular geographic area where orders have at least a threshold likelihood of being placed within a threshold period of time; and transmitting, to one or more computing devices associated with delivery workers who handle fulfillment of orders within the particular geographic area, the determined one or more locations.

In another implementation, a computer-implemented method includes presenting, by a mobile computing device that is associated with a delivery worker, information that identifies an order that is open and a selectable feature through which the delivery worker can accept responsibility for delivering at least a portion of the order; receiving, at the mobile computing device, user input selecting the selectable feature; continuously updating, in response to receiving the user input, an interface presented by the mobile computing device until the order has been delivered, the interface identifying a current location of a customer who placed the order relative to a current location of the mobile computing device as both of the current locations change over time, the continuously updating including: determining, by the mobile computing device, the current location of the mobile computing device; receiving, at the mobile computing device, the current location of the customer; and presenting, by the mobile computing device, the interface depicting the current location of the customer relative to the current location of the mobile computing device.

The details of one or more implementations are depicted in the associated drawings and the description thereof below. Certain implementations may provide one or more advantages. For example, location updates can be transmitted and displayed on mobile computing devices associated with both customers and delivery workers, which can help delivery workers more quickly and accurately locate customers, who may move to different locations after placing an order, and can help customers accurately monitor the progress of their orders. For instance, a golfer (example customer) can place an order while on the tee box of hole 5 at a golf course and can continue his/her round of golf. Updates on the golfer's location can be transmitted by the golfer's mobile computing device to a mobile computing device of a delivery worker (e.g., beverage/food cart driver) who is working to process and fulfill the golfer's order. The updated locations can be presented (e.g., displayed, audibly output) on the delivery worker's mobile device relative to the worker's current location, so that the worker can readily locate the golfer on the golf course while the golfer continues to play his/her round of golf. Likewise, location updates for the delivery worker can be transmitted to and presented on the golfer's mobile device, which can allow the golfer to monitor the location of the delivery worker in real time as both the golfer and the delivery worker continue to move. This feature can provide near constant feedback to the golfer on the status of his/her order, which can alleviate uncertainty as to whether the order has been received, is in transit, how soon delivery is expected, and/or other concerns.

In another example, a user interface feature can be presented (e.g., visually, audibly) on a customer's mobile computing device that provides an indication of when delivery is expected that can be updated in real-time based on movement the customer and/or the delivery worker. For example, the mobile computing device of a golfer (example customer) can display a progress bar that indicates what portion of the delivery workers trip to deliver the golfer's order has been completed and how much is remaining. Such a progress bar can be accompanied by additional information, such as text identifying a remaining time until delivery (e.g., “delivery estimated in 10 minutes”). Such features can allow for a customer to have more accurate and reliable information regarding his/her order, which can allow for a customer to make more informed decisions such as whether to wait at his/her current position for delivery, to continue along his/her originally intended path (e.g., progressing along a golf course), or to deviate from such a path to more quickly meet or locate the delivery worker.

In a further example, delivery workers can be provided with information to optimize their delivery routes, which can help increase their efficiency (e.g., smaller distance traveled to perform delivery services) and can increase their sales/revenue over a period of time (e.g., able to deliver more orders per hour). Additionally, route optimization can be provided to help position delivery workers at locations to service future orders that have not yet been received. For instance, heat maps can be generated to indicate where new orders are likely to be received over a future period of time (e.g., next 5 minutes, next 30 minutes, next hour) and can be provided to delivery workers on their mobile computing devices. Delivery workers can use these maps to position themselves at appropriate locations indicated on the heat maps as being likely places where new orders are likely to be received. Such positioning can allow for workers to reduce the time to service orders, which can increase the number of orders that workers may handle over a period of time and additionally improve customer satisfaction.

In another example, facilities and/or organization that use delivery workers, such as golf courses, stadiums, and festival organizers, can be able to provide the same or better levels of service to their customers with fewer delivery workers (e.g., fewer employees) and less delivery equipment (e.g., fewer beverage carts). By more strategically focusing resources (workers, delivery equipment) on locations where customers are, less ground needs to be covered which can allow for facilities and/or organizations can reduce the resources needed to provide the same level of service to customers.

Other features, objects, and advantages of the technology described in this document will be apparent from the description and the drawings, and from the claims.

### BRIEF DESCRIPTION OF THE DRAWINGS

FIG. 1 is a conceptual diagram of an example system to provide delivery to users of mobile computing devices.

FIGS. 2A-F depict an example golf course implementation involving order and delivery of goods to a golfer associated a mobile computing device who is moving about a golf course.

FIG. 3 is a conceptual diagram of an example system for providing route optimization information to a mobile computing device that is associated with a delivery worker.

FIGS. 4A-E are screenshots of example user interfaces that can be presented on a golfer's mobile computing device to order items for on-course delivery.

FIGS. 5A-H are screenshots of example user interfaces that can be presented on a beverage cart driver's mobile computing device to deliver orders to golfers on a golf course.

FIG. 6 is a screenshot of example user interface that can be presented on a beverage cart driver's mobile computing device to provide route optimization information to the beverage cart driver.

FIGS. 7A-T are screenshots of user interfaces on mobile computing devices through which orders can be placed and fulfilled.

Like reference symbols in the various drawings indicate like elements.

### DETAILED DESCRIPTION

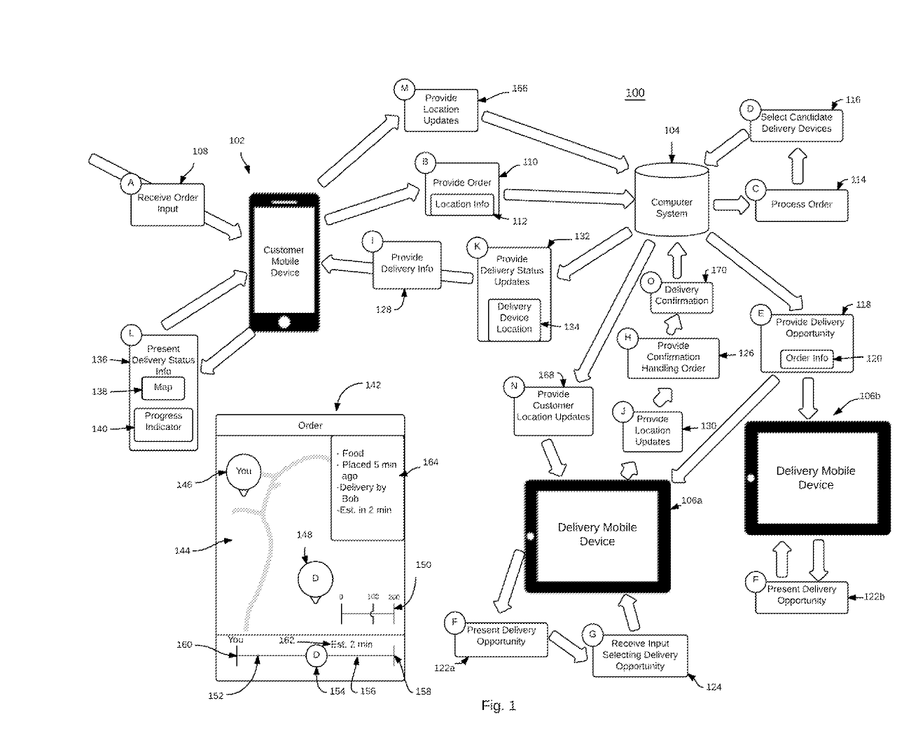

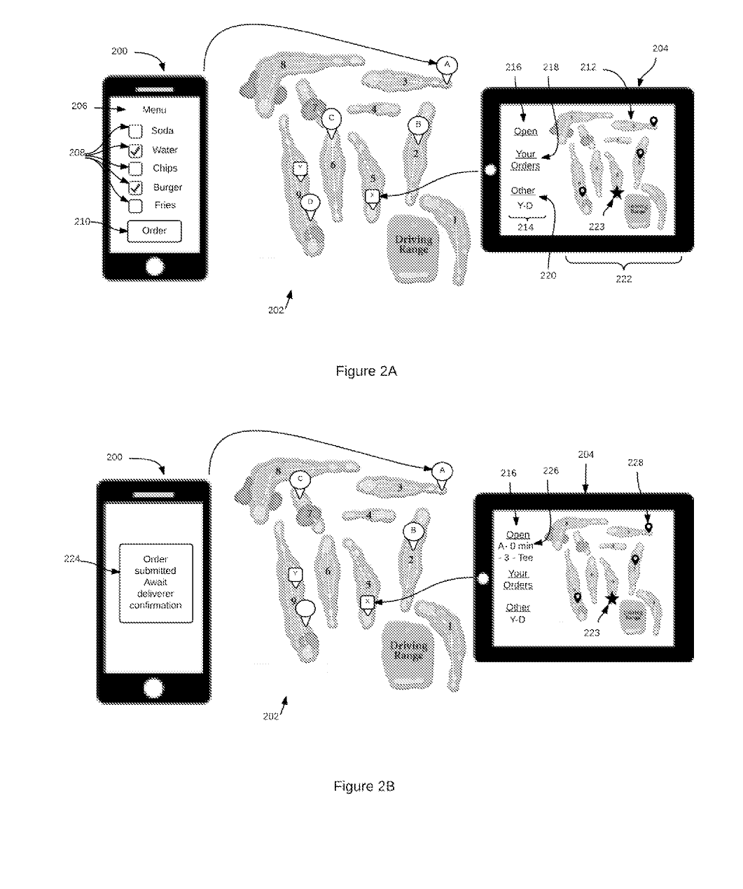

FIG. 1 is a conceptual diagram of an example system 100 to provide delivery to users of mobile computing devices. The example system 100 is depicted as including a customer mobile computing device 102 that places an order for delivery of goods/services to the location of the mobile computing device 102, which may change after the order has been placed and while the order is being delivered. The example system 100 also includes a computer system 104 that can process orders from customer mobile computing devices (e.g., the customer mobile computing device 102), identify one or more appropriate delivery mobile computing devices 106a-b to fulfill customer orders, and can obtain and provide information that is relevant to customer and delivery mobile computing devices to complete delivery of pending orders. The delivery mobile computing devices 106a-b can be associated with delivery workers, such as beverage cart drivers on a golf course and/or servers in a restaurant, and can provide information to fulfill orders from customers, such as the customer associated with the customer mobile computing device 102.

The customer mobile computing device 102 and the delivery mobile computing devices 106a-b can be any of a variety of appropriate mobile computing devices, such as smartphones (e.g., IPHONE, ANDROID smartphones), cell phones (e.g., feature phones), tablet computing devices (e.g., IPADs, ANDROID tablets), personal digital assistants (PDAs), computing devices embedded within vehicles (e.g., in-vehicle computer systems with displays and/or user interfaces built into the vehicles' consoles, vehicle mounted computing devices, golf carts with embedded computing devices), wearable computing devices (e.g., GOOGLE GLASS), laptop computers, netbook computers, and/or other appropriate mobile computing devices. The computer system 104 can be any of a variety of appropriate systems including one or more computing devices, such as computer servers, desktop computers, laptop computers, mobile computing devices, cloud computing systems, and/or other appropriate computing devices/systems. The customer mobile computing device 102, the delivery mobile computing devices 106a-b, and/or the computer system 104 can communicate with each other over one or more appropriate communication networks, such as the internet, mobile data networks (e.g., 3G/4G mobile data networks), wireless networks (e.g., Wi-Fi networks, BLUETOOTH networks), local area networks (LANs), wide area networks (WANs), virtual private networks (VPNs), fiber optic networks, cellular networks, and/or any combination thereof.

As indicated by step A (108), the customer mobile computing device 102 can receive order input. Such order input can include a variety of appropriate details, such as items that are being requested (e.g., food and beverage items, services), quantities of such items, payment information (e.g., credit card information, user identifier), and/or other appropriate details (e.g., special instructions for the order). The order input can be received in response to the customer mobile computing device 102 presenting a user (customer) of the device 102 with one or more available options, such as through a graphical user interface (GUI) displayed by the device 102 and/or an audible user interface (AUI) output through one or more speakers of the device 102. The input can be received through one or more appropriate input mechanisms on the device 102, such as through a touchscreen, physical buttons/keys, microphones, cameras, and/or other appropriate input devices (e.g., accelerometers, gyroscopes).

For example, the customer mobile computing device 102 can be a smartphone that is used by a golfer on a golf course to order items (e.g., food, beverages, golf equipment and clothes from the pro shop) for on-course delivery by a golf course worker. The customer mobile computing device 102 can download information (e.g., menus) identifying the items available for order at the golf course, such as from the computer system 104 or another computer system, and can present (e.g., display, audibly output) the information to a user of the customer mobile computing device 102. The mobile computing device 102 can provide one or more user interfaces (e.g., GUI, AUI) through which a user of the mobile computing device 102 can provide input to select and submit an order of items for delivery to the user while on the golf course. For instance, the user can select and submit an order for two beverages, a sandwich, a hot dog, and a sleeve of golf balls.

In response to receiving the input, the customer mobile computing device 102 can provide the order to the computer system 104, as indicated by step B (110). The order can be transmitted over one or more appropriate communication networks, as described above. In addition to providing information regarding the order (e.g., items ordered, quantities of such items, special instructions) and/or the user (customer) of the customer mobile computing device 102 who placed the order (e.g., user identifier, name, telephone number, email address, payment information, image), the information provided to the computer system 104 can also include location information 112 that identifies (or can be used by the computer system 104) to identify a current location of the customer mobile computing device 102. For example, the location information can be global positioning information (e.g., latitude and longitude, GPS coordinates, unprocessed GPS signal data), relative positing information (e.g., distance from one or more reference points, such as wireless beacons or other wireless transmitters), and/or human-readable information describing a location, such as a street/mailing address (e.g., “123 Maple St.”), a portion of a particular golf hole (e.g., “tee box of hole 7,” “fairway of hole 10”), a seat identifier (e.g., “section 10, row 20, seat 8”), and/or other location descriptions (e.g., “Field A at Park X”). The location information 112 can be determined by the customer mobile computing device 102, and may additionally include information regarding movement of the customer mobile computing device 102 (e.g., velocity, direction of movement, acceleration/deceleration) which can be used to identify possible locations where the customer mobile computing device 102 and its associated user are likely to be located at one or more future times.

The computer system 104 receives the order and location information from the customer mobile computing 102, and processes the order, as indicated by step C (114). Processing the order can include any of a variety of appropriate steps, such as checking whether the ordered items are still available and in-stock for purchase and/or delivery, processing payment information (e.g., processing a credit card payment, debiting a user account), and/or entering the order into one or more data structures (e.g., databases) that are used to track the progress of delivery of the order.

The computer system 104 can additionally select one or more candidate delivery workers and their associated delivery mobile computing devices to provide with the opportunity to deliver the order from the customer mobile computing device 102, as indicated by step D (116). For example, if the customer mobile computing device 102 places an order at an event (e.g., sporting event, concert, trade show, convention), the computer system 104 can select delivery workers who are servicing an area of the event where the customer mobile computing device 102 is currently located (e.g., based on a comparison of the customer's current location and the assigned areas for the delivery workers). In another example, the computer system 104 can provide order processing services for multiple golf courses. In such an example, the computer system 104 may select candidate delivery workers who work at a golf course where the user of the customer mobile computing device 102 is currently golfing. The candidate delivery workers can be selected based on any of a variety of appropriate factors, such as the proximity of the delivery workers to the user of the customer mobile computing device 102 (e.g., select all delivery workers located within a threshold distance of the user), assigned areas of service for the delivery workers, types of items stocked/readily obtainable by the delivery workers in comparison to the items order by the user (e.g., select delivery workers with ready access to items ordered by the user), capacity of the delivery workers to handle delivery of the user's order (e.g., evaluate current/committed load of orders for the delivery workers), and/or historical information regarding interactions between the user of the customer mobile computing device 102 and the candidate delivery workers (e.g., select delivery workers who have previous experience delivering to the user, select delivery workers who have received at least a threshold tip (percentage, total tip amount) from the user).

With the candidate delivery workers and their associated delivery mobile computing devices selected, the computer system 104 can provide opportunities to handle delivery of the user's order to the selected candidate delivery workers, as indicated by step E (118). In the depicted example, the selected candidate delivery workers are associated with the delivery mobile computing devices 106a-b, to which the opportunity to handle delivery of the order from the customer mobile device 102. The delivery mobile computing devices 106a-b can be provided with the order information 120, which can include any of a variety of appropriate details regarding the order, such as items that have been ordered, quantities of those items, a current location of the customer mobile computing device 102, a direction and speed at which the customer mobile computing device 102 is currently travelling, and/or one or more projected future locations where, given the current locations of the customer mobile computing device 102 and the delivery mobile computing devices 106a-b, the delivery worker would likely be able to meet the user of the customer mobile computing device 102 to deliver the ordered items.

The opportunity can be provided to the candidate delivery workers so as to allow the delivery workers to self-select handling of the order, allowing the delivery workers to have some level of autonomy in where, what, when, and to whom they deliver. The opportunity can be provided by the computer system 104 to all candidate delivery workers simultaneously or may be sent out in a cascading manner. In an example of simultaneous distribution of the opportunity, each of the delivery mobile computing devices 106a-b can be provided with the opportunity at the same time and a first delivery worker to accept the opportunity can be assigned the order. In an example of cascading distribution of the opportunity, a first delivery worker associated with one of the delivery mobile computing devices 106a-b can be provided with the opportunity first and, if the first delivery worker declines or does not accept the opportunity within a threshold period of time (e.g., 15 seconds, 30 seconds, 1 minute), the opportunity can additionally be provided to a second delivery worker associated with the other of the delivery mobile computing devices 106a-b.

In some implementations, instead of providing workers with the option to accept or decline orders for delivery, the computer system 104 may simply assign the order for delivery to a particular delivery worker and can provide notice of the assignment and the order to a mobile computing device associated with the delivery worker. Such a selection can be similar to the selection of the candidate delivery workers.

The delivery mobile computing device 106a-b can present the delivery opportunity to their associated users (delivery workers), as indicated by steps F (122a-b). Such presentation can be provided by the mobile computing devices 106a-b in any of a variety of appropriate ways, such as visually on a display, audibly through speakers, and/or through haptic feedback (e.g., vibration). The delivery mobile computing devices 106a-b can present the opportunity with a user interface (e.g., GUI, AUI) through which the corresponding users (delivery workers) can accept or decline handling of the order. In the depicted example, the delivery mobile computing device 106a receives input selecting (accepting) the delivery opportunity, as indicated by step G (124).

In response to receiving the selection, the delivery mobile computing device 106a can provide confirmation to the computer system 104 that the user associated with the delivery mobile computing device 106a will handle delivery of the order, as indicated by step H (126). The computer system 104 can receive the confirmation, can store information indicating that the delivery mobile computing device 106a is handling the order for the customer mobile device 102, and can provide notification of such to other appropriate computing devices, including the customer mobile computing device 102 and/or the other delivery mobile computing device 106b. For instance, the computer system 104 can provide information (e.g., information regarding handling of the order by the delivery worker, identity of the delivery worker, estimated time of delivery, current location of the delivery mobile computing device 106a) regarding the delivery of the order by the delivery mobile computing device 106a, as indicated by step I (128). Such information can be provided as part of a push notification that is sent by the computer system 104 to the customer mobile computing device 102. In another example, the computer system 104 can provide notification to the delivery mobile computing device 106b that the delivery mobile computing device 106a is handling the order, which may include causing the order to be moved from being listed under an “open orders” section of the user interface on the delivery mobile computing device 106b to an “assigned orders” section.

In addition to providing the confirmation, the delivery mobile computing device 106a can determine its location and provide location updates to the computer system 104, as indicated by step J (130). Such location updates can be provided repeatedly, such as at regular intervals of time (e.g., every second, every 5 seconds, every 15 seconds, every 30 seconds, every minute, every 3 minutes) and/or whenever the delivery mobile computing device 106a has moved at least a threshold distance (e.g., at least 10 feet, at least 20 feet, at least 50 feet, at 90 feet) since the last location update was provided to the computer system 104.

The computer system 104 can store the location information from the delivery mobile computing device 106a, and can use it to determine and provide delivery status updates to the customer mobile computing device 102, as indicated by step K (132). The delivery status updates can include information indicating a current location 134 of the delivery mobile device 106a as well as other appropriate information, such as an estimate of the time remaining until delivery of the order, progress of the order, and/or a listing of other orders that are assigned to the delivery mobile computing device 106a that are ahead of the user's order. The estimate of the time remaining and/or the progress of the order can be determined by the computer system 104 and/or by the customer mobile computing device 102 based on any of a variety of appropriate factors, such as the proximity of the delivery mobile computing device 106a to the customer mobile computing device 102 (e.g., raw distance between the devices, distance between the devices along one or more paths/routes), current travel conditions (e.g., weather, congestion/traffic, nighttime or daytime), and/or historical movement and delivery information (e.g., log of information regarding rate of speed and path/route of other customers previously located near the customer mobile computing device 102, log of information regarding rate of speed and path/route for other delivery workers located near the delivery mobile computing device 106a).

As indicated by step L (136), the customer mobile computing device 102 can present (e.g., graphically, audibly) the delivery status information, which can include the presentation of a map 138 and/or a progress indicator 140. Such delivery status information can be continuously or periodically updated until delivery of the order is complete, which can be beneficial to a user of the customer mobile computing device 102 who, without this information, may not know whether his/her order had been received, whether it is currently being handled, and/or when (if ever) delivery is expected. Additionally, this information can allow a user to assist in the delivery of the order, such as prompting the user of the customer mobile computing device 102 to identify himself/herself and/or flag down the delivery worker when the delivery mobile computing device 106a is nearby (e.g., within 100 yards, within 50 yards, within 20 yards). This can help improve the speed, accuracy, and efficiency with which orders are delivered. Additionally, the delivery status update information can provide a user of the customer mobile computing device 102 with information that may be useful to determine when modifications to his/her order are possible, such as before various stages of delivery have been met (e.g., before an order including hot food leaves a food preparation area, like a golf clubhouse).

The customer mobile computing device 102 can present any of a variety of appropriate information regarding the delivery status, such as a map 138 and/or a progress indicator 140. The map 138 can depict a location of the delivery mobile computing device 106a that is associated with the assigned delivery worker relative to the location of the customer mobile computing device 102. The progress indicator 140 can provide an indication as to how far delivery has progressed since the order was placed and/or since the delivery worker was assigned to deliver the order.

An example user interface 142 for providing delivery status information on the customer mobile computing device 102 is depicted as including an example map 144 that depicts an icon 146 representing the current location of the customer mobile computing device 102 and another icon 148 that represents the current location of the delivery mobile computing device 106a. A scale 150 for the map 144 can also be displayed so that the user can have an idea as to a distance between the customer mobile computing device 102 and the delivery mobile computing device 106a. Appropriate contextual information can also be depicted on the map 144, such as roads, paths, terrain features, buildings, other delivery workers, and/or other landmarks. For example, the map 144 can include a golf course map and depict the icons 146 and 148 at appropriate locations on the map 144.

The example user interface 142 can also depict a progress indicator 152 that, in this example, plots an icon 154 representing the delivery worker along a scale 156 that extends from a starting location 158 to an ending location 160 that corresponds to the location of the customer mobile computing device 102. The progress indicator 152 can be based on time and/or distance remaining until delivery is completed. Since the customer mobile computing device 102 and the delivery mobile computing device 106a may both move independent of each other and, thus, the time/distance remaining until delivery may progress at non-uniform rates, the progress of the icon 154 along the indicator 152 may be non-linear depending on the movements of the devices 102 and/or 106a across various locations.

The example user interface 142 can additionally include time information 162 that can indicate an estimate time remaining until delivery, which can be determined based on a variety of factors, as discussed above. Although not depicted, the user interface 142 can also include information indicating a distance remaining between the delivery worker and the user. As discussed above, such distances may be absolute distances (e.g., distances not taking into account routes/paths traveled) and/or distances based on routes/paths that are being traveled by the delivery worker and/or the user.

The user interface 142 is also depicted as including additional information 164 regarding the order and the delivery of the order. For instance, the example information 164 indicates the items that were ordered (food), how long ago the order was placed (5 minutes ago), the identity of the delivery worker handling the order (Bob), and an estimated time until delivery (2 minutes). Other details may also be included in the information 164, such as a picture of the delivery worker (Bob), a log of communication with the delivery worker or other workers helping to process and deliver the order (e.g., log of text messages between the user and the delivery worker or other workers, log of phone calls between the user and the delivery worker or other workers), and/or information regarding modifications to the order.

The delivery mobile computing device 106a may provide a similar user interface as the user interface 142. For instance, the customer mobile computing device 102 can provide location updates, as indicated in step M (166), to the computer system 104 which can be provided to the delivery mobile computing device 106, as indicated by step N (168). The delivery mobile computing device 106a can use these location updates to present a similar user interface to the user interface 142, which can include a map identifying a location of the customer mobile computing device 102 relative to the location of the delivery mobile computing device 106a, a progress indicator, information identifying the user of the customer mobile computing device 102 (e.g., user name, photo, description of attire), metrics regarding the delivery worker's performance (e.g., time elapsed on order versus expected time to delivery), and/or a communication log with the user.

The user interface on the delivery mobile device 106a may additionally include a feature through which the delivery mobile computing device 106a can indicate that the order has been successfully delivered. Selection of such a feature may only be enabled once the delivery mobile computing device 106a is within a threshold distance (e.g., 5 feet, 10 feet, 25 feet) of the customer mobile computing device 102, so as to avoid false indications that an order has been delivered. Once selected, a delivery confirmation can be provided by the delivery mobile computing device to the computer system 104, as indicated by step O (170). Once received, the computer system 104 can close the order. In some implementations, the computer system 104 may request confirmation from the customer mobile computing device 102 that the order was delivered to the user's satisfaction before closing the order.

Although the system 100 is described with regard to communication between the customer device 102 and the delivery device 106a being routed through the computer system 104, in some implementations that may not be the case. For example, in some implementations the computer system 104 may only serve to establish a peer-to-peer connection between the customer mobile computing device 102 and the delivery mobile computing devices 106a-b. Once the communication between the mobile computing devices 102 and 106a-b has been established (e.g., network addresses have been shared for the devices 102 and 106a), some or all of the communication between the customer mobile computing device 102 and the delivery mobile computing device 106a may take place without the computer system 104.

The system 100 can be used in any of a variety of appropriate contexts. For instance, the system 100 can be used to take and delivery orders from golfers on golf courses, users attending sporting events (e.g., baseball, football, hockey, soccer, basketball, horse racing), users attending music events (e.g., stadium concerts, music festivals, smaller venue shows), patrons at restaurants and bars, tourists (e.g., tourists travelling around a city), mobile workers (e.g., postal workers, salespeople, in-home service providers), and/or other appropriate users. Services and goods to be delivered as part of the system can be provided by any of a variety of vendors, such as food/beverage vendors, clothing vendors, sporting goods vendors, vendors that provide repair services (e.g., mechanics), vendors providing instructional/guide services, and/or other appropriate vendors.

Additionally, although described with regard to a user ordering specific items for delivery, the system 100 can also allow a user to receive service without identifying specific items. For example, a user of the customer mobile computing device 102 can press a button to request service without designating a specific order or items included in such an order, and the system 100 can proceed with performing steps B-O in response to the input (e.g., transmit delivery opportunity (step E, 118) to the delivery mobile computing devices 106a-b).

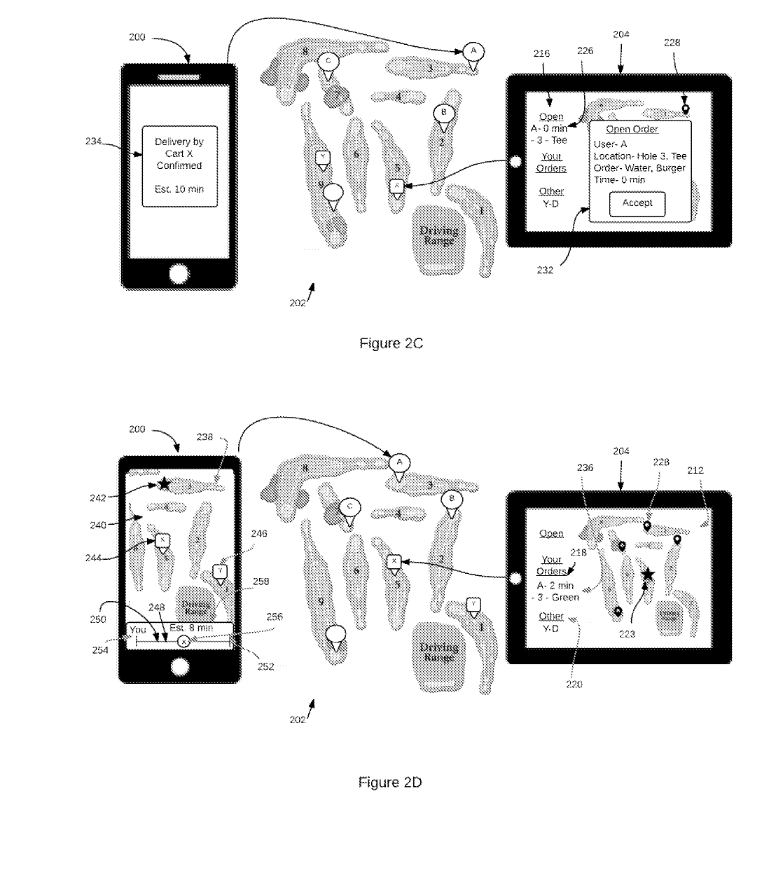

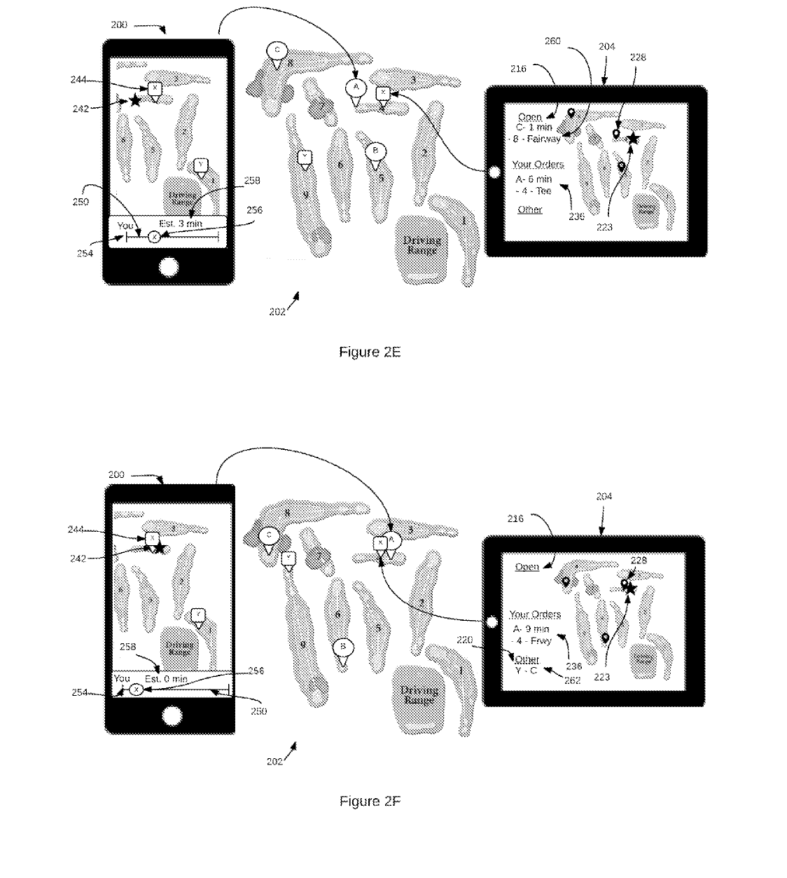

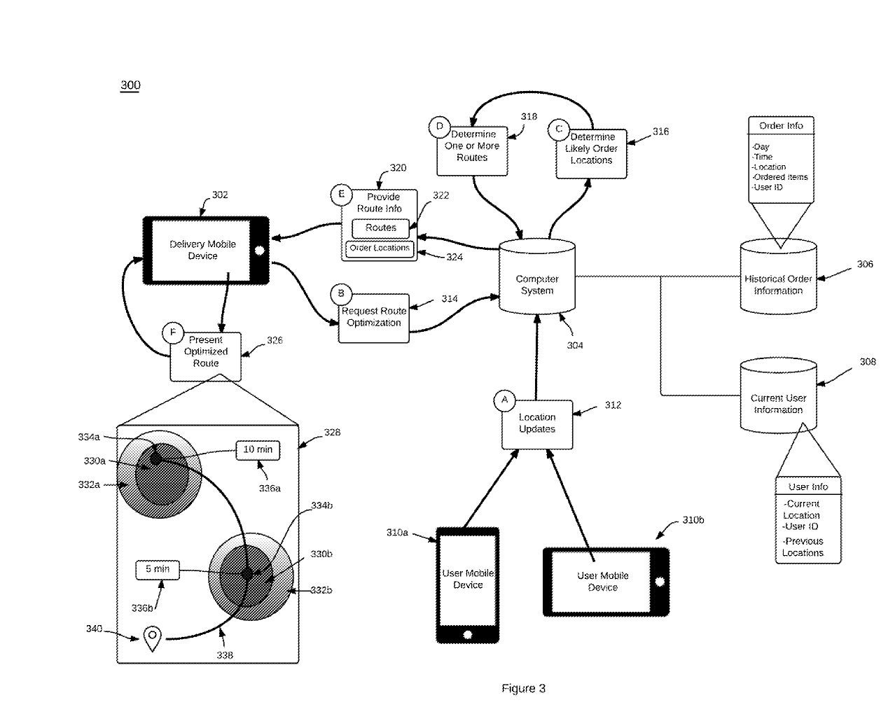

FIGS. 2A-F depict an example golf course implementation involving order and delivery of goods to a golfer associated a mobile computing device 200 who is moving about a golf course 202. In the depicted example, the goods are delivered to the golfer by a delivery worker associated with another mobile computing device 204. The mobile computing devices 200 and 204 can be any of a variety of appropriate mobile computing devices, such as those described above with regard to mobile computing devices 102 and 106a-b. For example, the mobile computing device 200 can be smartphone and the mobile computing device 204 can be a tablet computing device.

Referring to FIG. 2A, golfers A-D at various locations on the golf course 202 and are identified by the pins with circle heads. In this example, the user associated with the mobile computing device 200 is golfer A, who is located in the tee box area of hole 3. Golfers B, C, and D are depicted as being located in the fairway of hole 2, the green of hole 6, and the fairway of hole 9, respectively.

Delivery workers X and Y (e.g., beverage/food cart drivers) are also located on the example golf course 202 and are identified by the pins with square heads. In this example, the delivery worker associated with the mobile computing device 204 is delivery worker X, who is located at the green of hole 5. Delivery worker Y is identified as being located in the fairway of hole 9, near golfer D.

In the depicted example, the mobile computing device 200 displays a user interface 206 that includes a menu of items that are available for order and delivery, selectable features 208 (e.g., checkboxes, radio buttons) through which the user (golfer A) can select items, and a feature 210 (e.g., button) through which a user can submit the order. The user interface 206 can be provided using any of a variety of output and input features, such as a touchscreen display, a non-touchscreen display, physical buttons/keys, microphones, speakers, a stylus, cameras, and/or motion sensors. In the depicted example, the golfer A has selected water and a burger for delivery. Although not depicted, additional user interface features can be provided through which additional/alternative information can be entered by a user, such as features to designate quantities of items to be ordered, special instructions/requests for the items, and/or payment information.

The mobile computing device 204 displays a user interface 212 through which the user (delivery worker X) can monitor the status of orders and deliveries to the golfers on the golf course 202, and the locations of the golfers and other delivery workers. The user interface 212 includes a first area 214 that includes a first section 216 listing open orders, a second section 218 listing orders that are being handled by the user (delivery worker X) of the mobile computing device 204, and a third section 220 that lists orders that are being handled by other delivery workers (e.g., delivery worker Y). In the depicted state in FIG. 2A, there are currently no open orders, the delivery worker X does not have any assigned orders, and delivery worker Y is handling an order placed by golfer D. A second area 222 of the user interface 212 depicts a map of the golf course 202 that plots the current location of the mobile computing device 204, as indicated by the star icon 223, in relation to the current locations of the golfers on the course (golfers A-D) and the other delivery workers (delivery worker Y).

Referring to FIG. 2B, the user (golfer A) of the mobile computing device 200 has submitted his/her order for water and chips, and the mobile computing device 200 displays a message 224 regarding the order. The example message 224 indicates confirms that the order has been submitted and indicates that a delivery worker to handle the order is currently pending. As described above with regard to FIG. 1, after the order has been submitted by the mobile computing device 200 it can be processed by a computer system (e.g., the computer system 104), mobile computing devices that are associated with appropriate delivery workers can be selected (e.g., the mobile computing devices 106a-d), and the opportunity to handle the order can be transmitted to the selected mobile computing devices.

In this example, the opportunity to handle the new order for golfer A from the mobile computing device 200 is presented on the mobile computing device 204 in the open section 216 as an entry 226 for a new/open order. The entry 216 can include a variety of information about the open (unassigned) order, such as the identity of the user who placed the order (e.g., first name, last name, username), the time when the order was placed (e.g., timestamp), the time that has elapsed since the order was placed (e.g., 0 minutes, 2 minutes), a current location of the user who placed the order (e.g., hole number), and/or other information about the order (e.g., item ordered, special instructions/requests). In the depicted example, the entry 226 indicates that the order is from golfer A, that it was placed 0 minutes ago, and that golfer A is currently located at the tee box of hole 3. An icon 228 that is associated with golfer A can additionally change in some manner to indicate that the corresponding user has an open order (e.g., change color of the icon, shape of the icon, size of the icon, font for the icon). The user (delivery worker X) of the mobile computing device 204 can accept handling of the order from golfer A in any of a variety of ways, such as by selecting the entry 226, selecting the icon 228, and/or other appropriate forms of input (e.g., voice input indicating acceptance of the order).

Referring to FIG. 2C, the user (delivery worker X) selects the entry 226 and information 230 regarding the order is presented on the mobile computing device 204 which, in this example, includes an identity of the user placing the order (golfer A), a location where the user is located (hole 3, tee box), items included in the order (water, burger), and a current time that has elapsed since the order was placed (0 minutes). The mobile computing device 204 can also provide a feature 232 (e.g., button, verbal statement, gesture to be performed with the mobile computing device 204) through which the user (delivery worker X) can accept delivery responsibility for the order. In response to the user selecting the feature 232, acceptance of the order by delivery worker X can be transmitted by the mobile computing device 204 and, in some implementations through a computer system (e.g., the computer system 104), conformation that the order has been accepted by the delivery worker X can be transmitted and displayed as a message 234 (e.g., push notification) on the mobile computing device 200. Included in the message 234 can be an estimate of the time until the order will be delivered (e.g., estimate of 10 minutes until delivery).

Referring to FIG. 2D, after the user (delivery worker X) of the mobile computing device 204 has accepted handling of the golfer A's order, an entry 236 for the order can be added to the section 218 of the user interface 212 that identifies orders that the user (delivery worker X) is currently handling. The entry 236 can include information that is continuously be updated until delivery is complete, such as the current location of golfer A and the mobile computing device 200 and a current time that has elapsed since the order was placed. In this example depicted in FIG. 2D, the entry 236 has been updated to indicate that golfer A has moved to the green of hole 3 since the order was placed and that 2 minutes have elapsed since the order was placed. Additionally, the icon 228 associated with the golfer A can change again in a manner to indicate that the order associated with that golfer A is being handled by delivery worker X and the mobile computing device 204 (e.g., change the color of icon 228, size of the icon 228, shape of the icon 228, font associated with the icon 228).

In FIG. 2D, an entry for the order from golfer D that was being handled by delivery worker Y is no longer listed in the section 220, which lists orders that are being handled by other delivery workers. This section 220 is also continuously updated based on the status of other orders. As those other orders are fulfilled (or as the status of these orders otherwise changes, such as the delivery worker handling the order changing or a delivery worker releasing an order so that it becomes an open order again), the entries in the section 220 are updated.

As depicted in FIG. 2D, the mobile computing device 200 can present a user interface 238 (similar to the user interface 142) that includes a map 240 that depicts the real-time location of, at least, the mobile computing device 200 and one or more of the delivery workers for the golf course 202. In the depicted example, the map 240 includes an icon 242 that corresponds to the location of the mobile computing device 200, an icon 244 that corresponds to the location of the mobile computing device 204 that is associated with the delivery worker X delivering the golfer A's order, and an icon 246 identifying other delivery workers (delivery worker Y). The icon 244 is presented in a manner to highlight the delivery worker X who is delivering the order, such as through the icon 244 having a particular color, shape, size, text, and/or other attributes (e.g., animation) to indicate that the corresponding delivery worker is handling the golfer A's order.

Additionally, the user interface is depicted as including a progression indicator 248, which can be similar to the progression indicator 152 described above with regard to FIG. 1. The progression indicator 248 includes a scale 250 with a starting point 252 and an ending point 254 that indicates how far the delivery process has progressed from a starting point (e.g., since the order was placed by the golfer A, since the order was accepted by the delivery worker X). The scale 250 can be based on overhead distance, distance along one or more routes (e.g., progression of the golf course 202, historical routes traveled by golfers and/or delivery workers on the golf course 202, historical routes traveled by the specific golfer A and the delivery worker X), time, or any combination thereof. The progress is indicated by the location of an icon 256 corresponding to the delivery worker X along the scale 250. The progress indicator 248 also includes text 258 that identifies an estimated time remaining until delivery.

The progress of the icon 256 along the scale 250 and/or the textual estimate of the time remaining 258 can be continuously updated based on movements of both the golfer A and the delivery worker X on the golf course 202. Accordingly, the rate at which the progress changes may be non-linear. For example, when the golfer A and the delivery worker X are travelling toward each other, such as when the golfer A moves from the tee box to the green of hole 3 while the delivery worker X simultaneously moves in a reverse direction along the golf course 202 (example route) from the green to the fairway of hole 5, the icon 256 may progress along the scale 250 more quickly and the estimated time remaining 258 may decrease more quickly than when only one of those two actors (golfer A and delivery worker X) are moving.

Referring to FIG. 2E, the golfer A has moved to the tee box of hole 4 and the delivery worker X has moved to the fairway of hole 4, closing the distance between the golfer A and the delivery worker X. The golfer A and the delivery worker X getting closer to each other along the golf course 202 is indicated on the map 240 by the location of the icon 242 corresponding to the golfer A and the mobile computing device 200 and the location of the icon 244 corresponding to the delivery worker X and the mobile computing device 204 being updated to reflect their current position. Additionally, the icon 256 can move along the scale 250 of the progress indicator and closer to the ending point 254, and the estimated time remaining until delivery 258 can be updated to reflect that less time is currently remaining until delivery based, at least in part, on the shorter distance (overhead and/or along the route of the golf course 202) separating the golfer A and the delivery worker X.

Likewise, the user interface 212 of the mobile computing device 204 is automatically and continuously updated to identify that closing distance between the golfer A and the delivery worker X. For example, the icon 223 corresponding to the location of the mobile computing device 204 and the icon 228 corresponding to the location of the mobile computing device 200 are updated to reflect the current locations of the golfer A and the delivery worker X. Additionally, the entry 236 for the order is updated with a textual description of the location of the mobile computing device and golfer A, which in the depicted example, is indicated as “4, tee” (the tee box of hole 4). The entry 236 is also updated to indicate an amount of time that has elapsed since the order was placed (e.g., 6 minutes).

Also depicted in FIG. 2E, a new entry 260 for an open order from golfer C is presented in the open order section 216. The new entry 260 indicates that the golfer C is currently on the fairway of hole 7 and that the order has been pending for 1 minute since it was placed.

Referring to FIG. 2F, the delivery worker X has met the golfer A on the fairway of hole 4. The user interfaces on the mobile computing devices 200 and 204 can be updated to indicate this. For example, the user interface on the mobile computing device 200 depicts the icon 242 for the mobile computing device 200 being at the same location as the icon 244 for the mobile computing device 204, the icon 256 has progressed down to the ending point 254 for the order, and the textual estimate 258 of the delivery time remaining indicates that “0 minutes” are remaining. In another example, the user interface of the mobile computing device 204 depicts the icons 223 and 228 being at the same location.

Also depicted in FIG. 2F, the formerly open order from golfer C has been accepted by the other delivery worker Y, and an entry 262 in the orders handled by other delivery worker's section 220 indicates as much.

Although not depicted in this example, the mobile computing device 200 and/or the mobile computing device 204 can provide features (e.g., buttons, voice input prompts) through which delivery of the order can be confirmed by the golfer A and/or the delivery worker X. Such features may be disabled until the mobile computing device 200 and the mobile computing device 204 are within a threshold distance of each other (e.g., within 5 feet of each other, within 10 feet of each other, within 25 feet of each other).

Additionally, although FIGS. 2A-F are described with regard to a user ordering specific items for delivery, the same user interfaces and steps can be performed when a user requests service without identifying specific items. For example, a user of the mobile computing device 200 can press a button (e.g., the button 210) to request service without designating a specific order or items to be included in such an order, and the progression depicted in FIGS. 2B-F can proceed in response to the input (e.g., present entry 226 for the delivery opportunity on the mobile computing device 204, as depicted in FIG. 2B).

FIG. 3 is a conceptual diagram of an example system 300 for providing route optimization information to a mobile computing device 302 that is associated with a delivery worker. The example system 300 can be used alone or in combination with the other systems and devices described in this document, such as the example system 100 described above with regard to FIG. 1 and/or the computing devices 200 and 204 described above with regard to FIGS. 2A-F.

The example system 300 includes a computer system 304 that determines the route optimization information, such as suggested routes that the delivery worker using the mobile computing device 302 should travel and/or information suggesting locations at which future orders are likely to be placed (e.g., heatmaps), using any of a variety of data sources, such as a data repository of historical order information 306 and/or a data repository of current user information 308. The example system 300 can also include example mobile computing devices 310a-b which can be associated with users who are currently located within one or more areas that are being serviced by the delivery worker, such as golfers on a golf course that the delivery worker is servicing, users attending an event (e.g., concert, sporting event, festival) that the delivery worker is servicing, and/or users at a restaurant or bar that the delivery worker is servicing.

The delivery mobile computing device 302 and the user mobile computing devices 310a-b can be any of a variety of appropriate mobile computing devices, and can be similar to the mobile computing devices 102 and 106a-b described above with regard to FIG. 1. The delivery mobile computing device 302 can be the same as the delivery mobile computing devices 106a-b and/or the delivery mobile computing device 204. The user mobile computing devices 310a-b can be the same as the customer mobile computing device 102 and/or the mobile computing device 200. The computer system 304 can be any of a variety of appropriate computer system, and can be similar to the computer system 104 described above with regard to FIG. 1. The computer system 304 can be the same as the computer system 104. The data repositories 306 and 308 can include any of a variety of appropriate data storage devices and/or systems, and may be local to the computer system 304 and/or remote from the computer system 304 (e.g., accessible over one or more network connections).

In the depicted example, the user mobile computing devices 310a-b provide location updates to the computer system 304, as indicated by step A (312). For example, the user mobile computing devices 310a-b can run a mobile application that, based on user consent, provides location updates while the user mobile computing devices 310a-b are within a geographic area (e.g., on a golf course, within stadium, within a restaurant/bar). For instance, the user mobile computing devices 310a-b can be golfers located on the golf course 202 and can provide location updates as to the current location of the golfers on the golf course 202. The location updates can include absolute location information (e.g., latitude and longitude coordinates, address, GPS coordinates), can include raw/unprocessed location signals detected by the mobile computing devices 310a-b (e.g., detected GPS signal information, detected wireless beacon signal information), and/or can include relative location information (e.g., distance from a landmark or object, such as a wireless beacon). The location information can be human-readable information describing the location of the mobile computing devices 310a-b, such as a street/mailing address (e.g., “123 Maple St.”), a portion of a particular golf hole (e.g., “tee box of hole 7,” “fairway of hole 10”), a seat identifier (e.g., “section 10, row 20, seat 8”), and/or other location descriptions (e.g., “Field A at Park X”).

The computer system 304 can store the location updates in the repository of current user information 308, which can include a variety of information regarding users of the computer system 304. For example, the current user information 308 can include information describing the current location of the users, a user ID (e.g., username, email address, phone number, other unique identifier), and previous locations where the user has been located as obtained through previous location updates. The current location and previous locations of the users can be time-stamped, which can be used by the computer system 304 to determine rates of speed with which the users are moving around a geographic area and to also predict where the users are likely to be moving in the future and/or rates of speed with which they are likely to move to those future locations. For instance, the users associated with the mobile computing devices 310a-b can be golfers on a golf course. The previous location updates can detail the where and how quickly the golfers have been moving around the golf course, and can be used to estimate how quickly the golfers are likely to arrive at upcoming holes on the golf course (e.g., likely to arrive at the tee box on hole 14 in 20 minutes, likely to arrive at the green on hole 14 in 30 minutes).

Although not depicted in FIG. 3, the computer system 304 can store information regarding orders that are received by users and delivered, such as the example orders that are described above with regard to FIGS. 1 and 2A-F. The computer system 304 can store the information regarding the orders in the historical order information repository 304. The order information that is stored can include a variety of details, such as the day on which orders are placed (e.g., day of the week (Monday-Sunday), calendar date (July 1)), the time at which the orders are placed (e.g., 8:00 am, noon, 5:00 pm, nighttime, daytime), locations at which the orders are placed (e.g., hole 5 on a golf course, near the pool at a resort, section 100 in a stadium), items that were ordered (e.g., goods, services), and user IDs for the users placing the orders (e.g., username, email address, phone number, other unique identifier). Other information regarding the orders that may indicate times and/or places at which orders are more or less likely to be placed by users and received by the computer system 304 can also be obtained and stored by the computer system 304 in the historical order information repository 306, such as information describing the weather when the orders are received (e.g., temperature, precipitation, forecasted weather, weather over a time period preceding the orders), the time of year when the orders are received (e.g., spring, summer, fall, holiday), types of events at which the orders are received (e.g., rock concert, play, festival), relative timing during an event when orders are received (e.g., during an intermission, 10 minutes preceding an intermission, during an opening act, when the event is 60% complete), and/or other appropriate information.

The computer system 304 can receive a request for an optimized route from the delivery mobile computing device 302, as indicated by step B (314). For example, the delivery worker using the delivery mobile computing device 304 can request an optimized route by providing any of a variety of appropriate inputs to the device 304 (e.g., selecting a virtual or physical button/key, providing voice input, shaking the device 304). In response, the delivery mobile computing device 302 can submit the request to the computer system 304. In some implementations, the delivery mobile computing device 302 may automatically submit such a request to the computer system 304, such as on a periodic basis (e.g., every 15 minutes, every 5 minutes) and/or when appropriate times for such a route are determined (e.g., when the deliver mobile device 302 is not currently handling delivery of any orders, when is at one or more particular locations, when the device 302 is stopped for at least a threshold period of time). The request for an optimized route can additionally include the current location of the delivery mobile computing device 302 and/or the identity of the delivery worker (e.g., delivery worker ID, other unique identifier for the delivery worker). The historical order information 306 can additionally include store information regarding the delivery workers who handled the orders, how long delivery of those orders took, and/or information indicating customer satisfaction with the orders (e.g., tip amount, customer rating of the service).

In response to receiving the request, the computer system 314 can determine one or more locations at which orders are likely to be received, as indicated by step C (316). Such determinations can be based on one or more portions of information from the current user information repository 308 and/or the historical order information repository 306. For example, the computer system 304 can determine where, given the current locations of the user mobile computing devices 310a-b and/or other information regarding current conditions (e.g., day, time, weather), the users associated with these devices are likely to place orders based on locations where those users and/or other users have placed orders using the information stored in the historical order information repository 306. For instance, the user associated with device 310a may have previously placed orders for food and beverages when at a particular hole on a golf course (e.g., tee box at hole 5, fairway on hole 14). The computer system 304 can use that information to determine that the user associated with device 310a is likely to place orders from similar locations on the golf course.

The computer system 304 can use any of a variety of appropriate techniques to determine where orders are likely to be placed. In one example, the computer system 304 can generate information (e.g., heatmap) that plots locations where orders have historically been placed without regard for current user locations, current user identities, and other current information (e.g., weather, time, day, status of ongoing event). For instance, in a golf course example the computer system 304 can generate a heatmap that identifies areas on the golf course where orders are frequently placed by golfers and identifies other areas on the golf course where orders are less frequently placed by golfers. Such a heatmaps can provide guidance to the delivery worker as to where he/she should best position himself/herself to be nearby where orders are likely to be placed, so that there can be minimal, if any, delay in fulfilling the golfers' orders.

In another example, the computer system 304 can generate information based on current user locations, current user identities, and/or other current information. For instance, the computer system 304 can compare the current user locations, their identities and historical order behavior, and the other current information (e.g., day, time, weather) to the historical information for orders to determine where orders are likely to be received. Particular weight can be provided for orders that historical information for orders received from the users associated with the mobile computing devices 310a-b under similar current conditions (e.g., day, time, weather) and within the same geographic area (e.g., orders placed at the same golf course). Historical order information for the users associated with the mobile computing devices 310a-b from other geographic areas (e.g., orders placed at other golf courses) may also be weighted when the other orders were placed at similar venues (e.g., weight for information from other golf courses when the mobile computing devices 310a-b are at a golf course, but not when the mobile computing devices 310a-b are at a music concert). Historical order information for other users who are different from the users associated with the mobile computing devices 310a-b can be weighted under a variety of circumstances, such as when the other users have similar order patterns/behavior to the users associated with the devices 310a-b (e.g., other users and the users associated with the devices 310a-b order similar items, place orders at similar locations and under similar conditions), when the other users are similar demographically to the users associated with the devices 310a-b (e.g., similar in age, gender, city/state of residence, interests), and/or other appropriate measures of similarity. Historical order information for orders placed under similar conditions (e.g., day of the week, temperature, weather forecast, time of year, time of day) can additionally be weighted when similar to the current conditions for the users of the devices 310a-b. Such determinations by the computer system 304 can be performed using any of a variety of appropriate techniques, such as using any of a variety of appropriate machine learning algorithms (e.g., neural network algorithms, clustering algorithms, decisions trees).

Using the determined locations/areas where orders are likely to be placed, the current location of the delivery mobile computing device 302, and/or current orders that the delivery mobile computing device 302 is handling, the computer system 304 can determine one or more optimized routes for the delivery worker associated with the device 302 to travel along, as indicated by step D (318). For example, the computer system 304 can identify times when the delivery worker would likely be able to travel to the likely order locations, can compare such times to the times when orders are likely to be placed at such locations, and can generate a route that will maximize the delivery worker's presence at such locations at the appropriate times. Such a recommendation can take into account orders that the delivery worker is currently handling, including locations to which the delivery worker is likely to travel to fulfill such orders. For instance, in a golf course example where the delivery mobile computing device 302 is currently located at the tee box of hole 2, the computer system 304 determines that orders are likely to be placed at the fairway of hole 5 in 15 minutes and the tee box of hole 7 in 5 minutes, and it will likely take the delivery worker 6 minutes to travel to the tee box of hole 7 and 3 minutes to travel to the fairway of hole 5, the computer system 304 can recommend a route where the delivery worker drives to the tee box of hole 7 first and then to the fairway of hole 5 second.

The computer system 304 can provide the determined locations 324 where orders are likely to be placed and/or the route recommendation information 322 to the delivery mobile computing device 302, as indicated by step E (320). The route information 322 can include any of a variety of appropriate information, such as information identifying locations to which the delivery worker should travel (e.g., GPS coordinates, human-readable location information), an order in which the delivery worker should travel to the locations (e.g., travel to location A first, location B second), and/or timing information for when the orders are likely to be placed at the locations (e.g., arrive at location A in 10 minutes, arrive at location B in 20 minutes). The order location information 324 can include any of a variety of appropriate information, such as information identifying the locations (e.g., GPS coordinates, human-readable location information), confidence levels with which the computer system 304 has determined an order to be placed at the location (e.g., 0-100% confidence level), items that are estimated to be ordered at the locations (e.g., beverages, food), and/or timing information indicating when orders are likely to be received at the locations (e.g., within 10 minutes, within 20 minutes). The computer system 304 may provide the order location information 324 in any of a variety of appropriate formats, such as information that can be used to provide text and/or graphics (e.g., heatmaps) on the device 302 that are useful to the delivery worker.

The delivery mobile computing device 302 can present information regarding an optimized route based on the information received from the computer system 304, as indicated by step F (326). Such a presentation can be via any of a variety of appropriate output devices on the mobile computing device 302, such as visual output using one or more display devices, audio output using one or more speakers, and/or haptic feedback using one or more haptic devices. In an example user interface 328 presenting route optimization information to the delivery worker, a heatmap with first areas 330a-b that have a high likelihood of orders being placed by users and second areas 332a-b that have a lesser likelihood of orders being placed by users are depicted; particular recommendation locations 334a-b to which the deliver worker should travel are identified; timing information 336a-b for the delivery worker to arrive at the recommended locations 334a-b is presented; and a suggested route 338 for the delivery worker, who is identified at his/her current location by icon 340, to travel along are presented. Other interfaces may also be used, such as textual lists of locations, can also be presented on the device 302. For instance, the delivery worker of the mobile device 302 may select a preferred interface (e.g., graphical, textual, audio) through which the route recommendation information can be presented. The example interface 328 may be overlaid one or more appropriate maps, such as a map of a golf course, a seating chart of a stadium, a map of an event, or other appropriate maps.

In some implementations, the steps C-E may be performed by the delivery mobile computing device 302 alone or in combination through communication with the computer system 304. For example, the delivery mobile computing device 302 may have access to the data repositories 306 and 308, either directly or through the computer system 304, and may perform steps C-E to determine route optimization information.

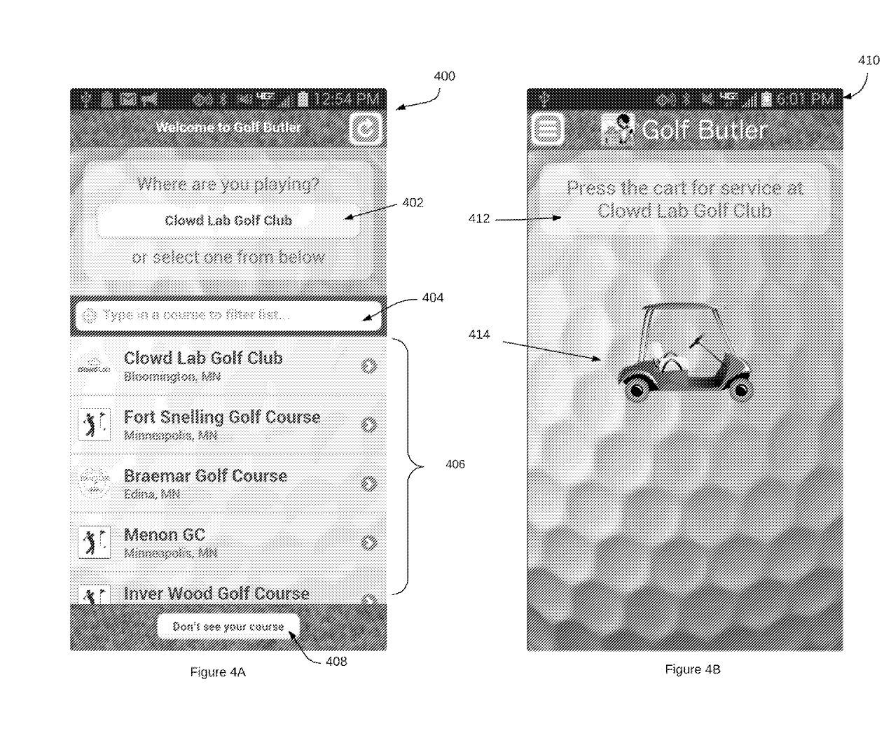

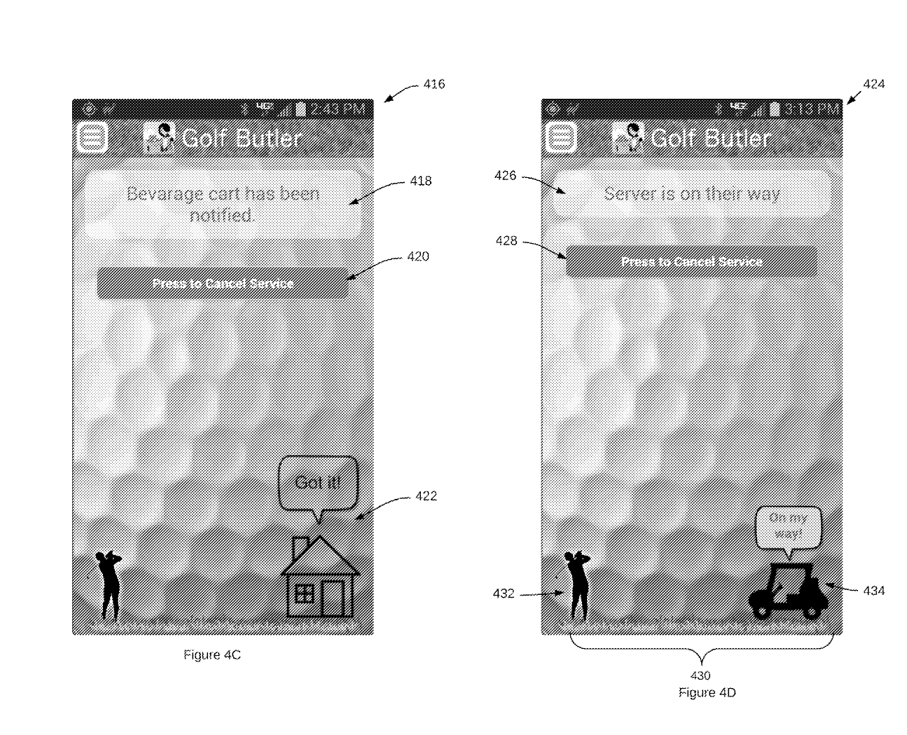

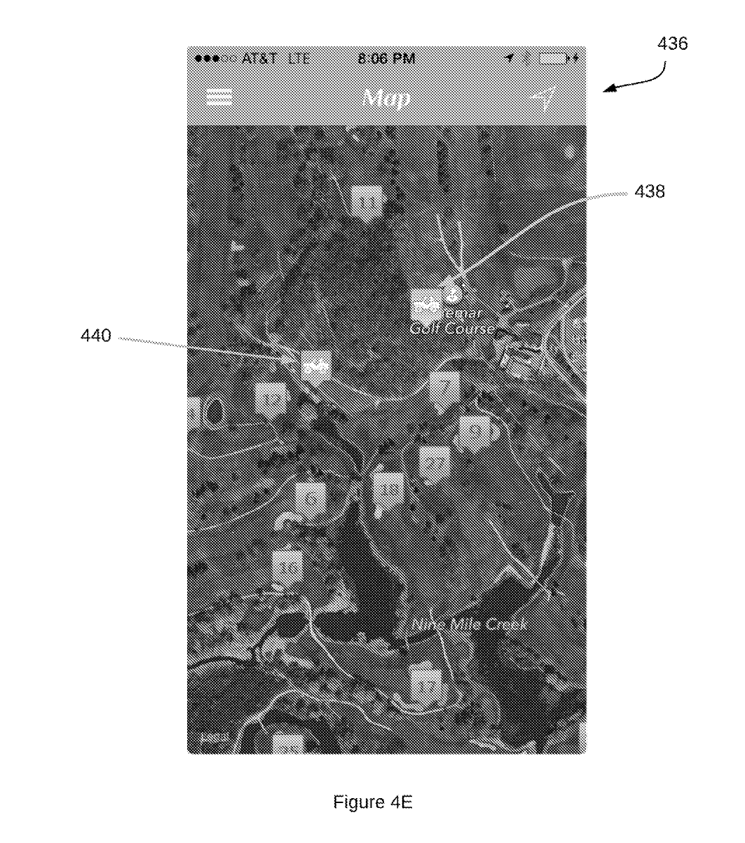

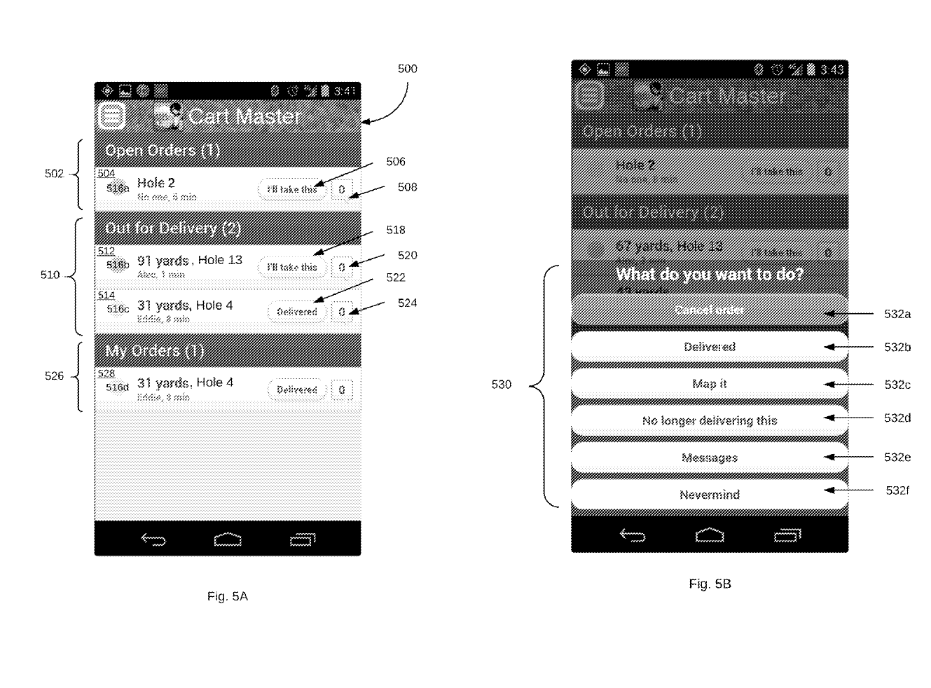

FIGS. 4A-E are screenshots of example user interfaces that can be presented on a golfer's mobile computing device to order items for on-course delivery. For example, the screenshots depicted in FIGS. 4A-E can be presented on mobile computing devices, for example, as part of a mobile application running on the mobile computing devices, such as the customer mobile computing device 102, the mobile computing device 200, the mobile computing devices 310a-b, and/or other appropriate mobile computing devices. Although depicted for golf course implementations, the features depicted and described with regard to FIGS. 4A-E can be adapted and used in other implementations, such as events (e.g., sporting events, music concerts, festivals), restaurants/bars, and/or other appropriate contexts.

Referring to FIG. 4A, an example user interface 400 is depicted through which a user (e.g., golfer) of the mobile computing device displaying the interface 400 can select a golf course on which the user is located/playing golf. The example interface 400 includes a pre-selected/suggested golf course 402, which may be automatically selected by the mobile computing device based on a comparison of the location of the mobile computing device with geographic areas that correspond to golf courses. The interface 400 additionally includes an input field 404 through which the user can enter the name (or portion thereof) of a course to filter the golf courses that are included in the selectable list 406 of golf courses. The interface 400 also includes a selectable element 408 (e.g., button) that the user can use to indicate that a golf course the user will be using is not included in the list 406. Selection of the element 408 can provide an interface through which a user can enter the name of golf course that is missing from the list 406. Any of a variety of actions can be taken in response to receiving the name of a golf course, such as notifying appropriate entities (e.g., people, computer systems) associated with the named golf courses that users have requested that the golf courses be added to the list 406.

Referring to FIG. 4B, an example user interface 410 is depicted through which a user can send a request for service from a beverage/food cart at the golf course selected in interface 400, which in the depicted example is Clowd Lab Golf Course, as indicated by the text 412. The example interface 410 includes a selectable element 414 (e.g., graphic of a golf cart) that the user can select to cause the mobile computing device providing the interface 410 to transmit a request for service, such as transmission of the order at step B (110) by the customer mobile computing device 102 as described above with regard to FIG. 1. The example user interface 410 can be displayed after a user has selected a golf course from user interface 400.

Referring to FIG. 4C, an example user interface 416 is depicted through which a user is notified of the status of his/her request. For example, the interface 416 displays a first notification 418 indicating that the beverage cart has been notified of the request for service, which can be received through the interface 410. Likewise, were an order to be placed, such as the example orders described above with regard to systems 100 and 200, a notification similar to the notification 418 can be received and presented on a mobile computing device indicating that the order has been received. The notification 418 can be a push notification that is received by the mobile computing device providing the interface 418. The notification can be provided by a computer system that is facilitating delivery of services to the mobile computing device, such as the computer system 104.

The example interface 418 is depicted as including a selectable feature 420 (e.g., button) that a user can select to cancel the request for service after it has been placed. The example interface 418 also includes an icon and corresponding notification 422 that indicates that the request for service has been received by a system managing orders for the golf course, such as the computer system 104 which may also manage orders for other golf courses.

Referring to FIG. 4D, an example user interface 424 is depicted through which a user is notified when his/her request for service (or order) has been assigned/accepted for handling by a particular server (delivery worker). For example, the interface 424 includes a notification 426 that indicates that the server who accepted/was assigned the service request is en route to fulfill the user's request. A graphical element 428, similar to the graphical element 420, is presented through which the request for service can be canceled. A progress indicator graphical element 430, which can be similar to the progress indicator 152 described above with regard to FIG. 1, is presented at the bottom of the interface. In this example, the user (golfer) that requested the service is indicated by the golfer icon 432 and the server (delivery worker) handling the request is indicated by the cart icon 434, which can move toward the golfer icon 432 along the progress indicator 430.

Referring to FIG. 4E, an example user interface 436 is depicted which presents a map of a golf course with icons 438 and 440 representing beverage carts that are servicing the golf course. In this example, the icons 438 and 440 are different from each other so as to identify the particular beverage cart that is servicing the request that was placed through interface 410. In this example, the icon 438 indicates that the beverage cart corresponding to this icon is handling the service request. The interface 436 can allow the user of the mobile computing device providing the interface 436 to track the status of the beverage cart handling his/her request as well as the location of other beverage carts, in case assistance from the other beverage cart may be needed.

Although not depicted, the interfaces depicted in FIGS. 4A-E may additionally include features through which users can select and place orders for items (e.g., food, beverages, golf equipment, services), communicate directly with beverage cart drivers (e.g., text message, phone call, video chat), view items that are currently available/in-stock on the beverage carts (e.g., view beverage cart supplies), and/or select options to receive notifications based on proximity of beverage cart drivers to the users so as to provide the users with advance notice when a beverage cart driver is nearby so that an order/request can be placed and quickly fulfilled. Other features are also possible.

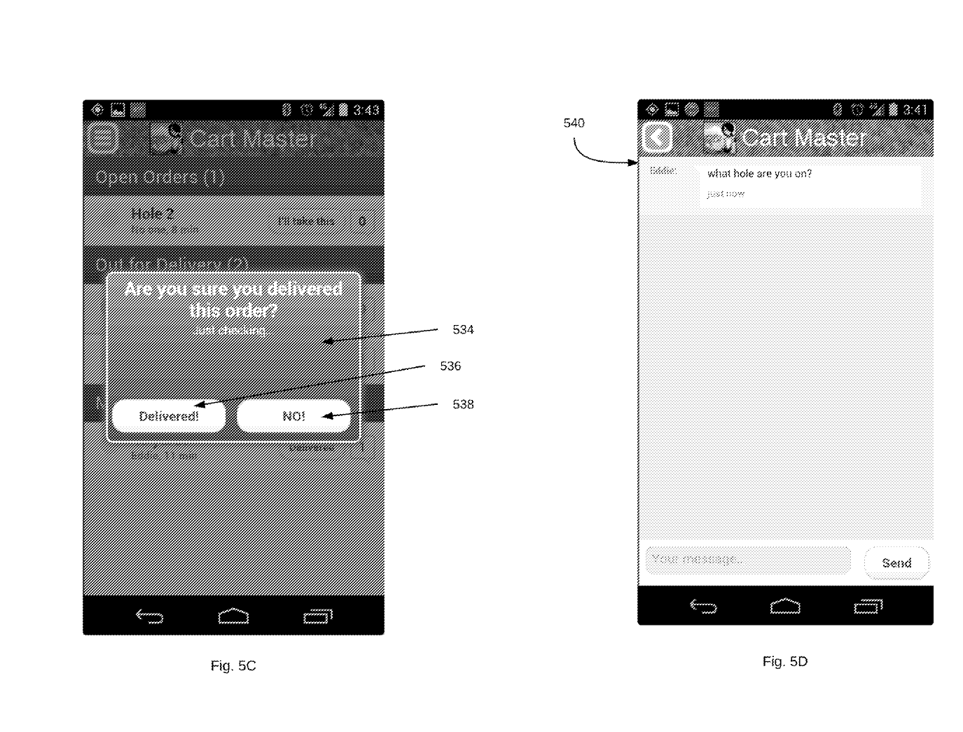

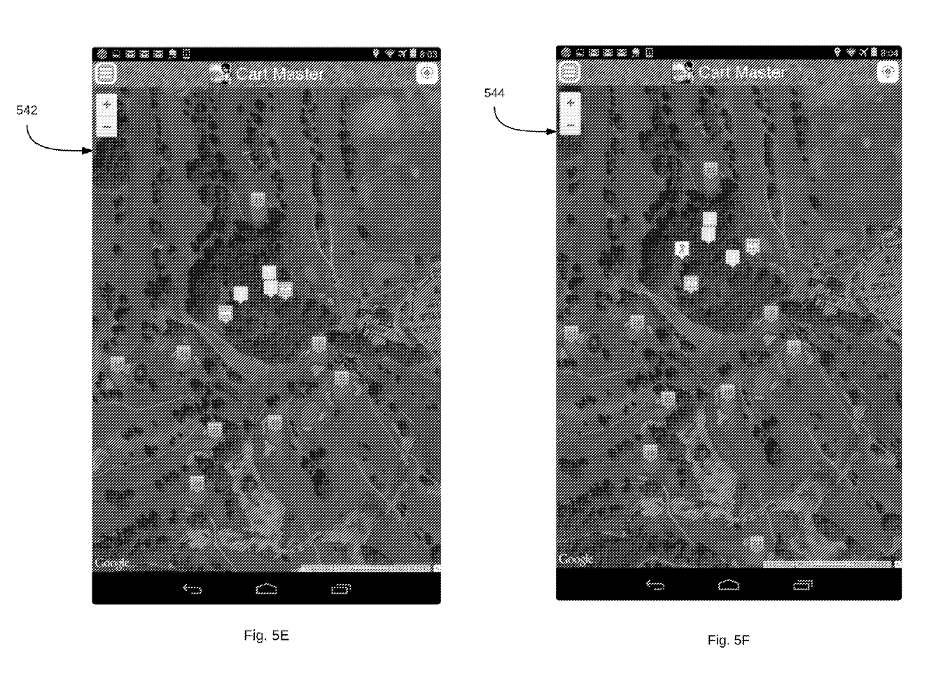

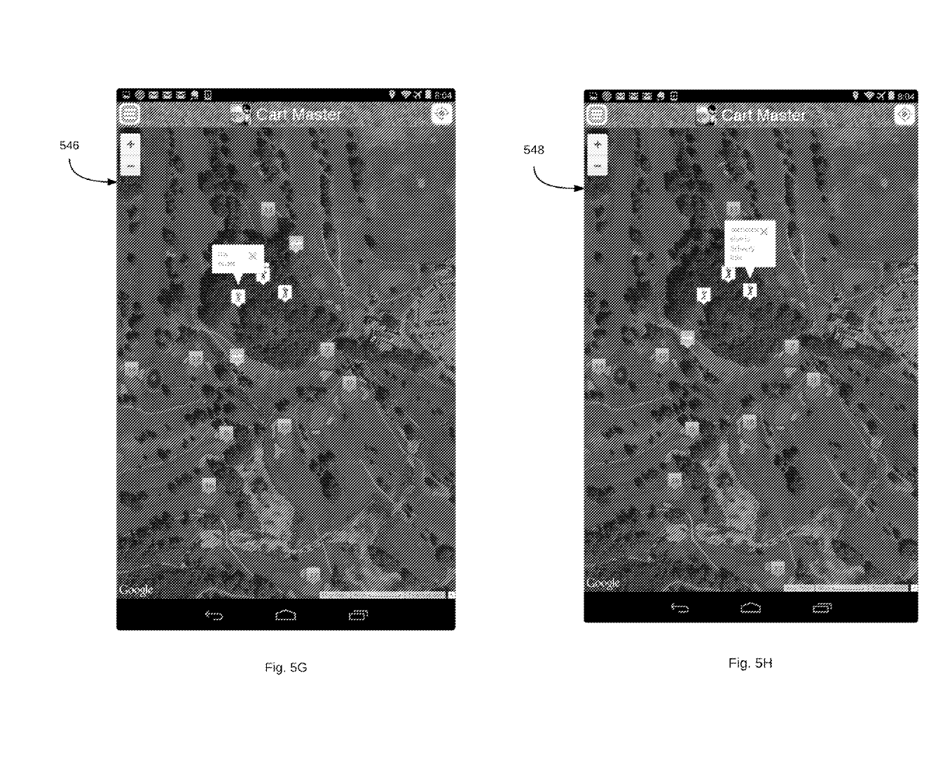

FIGS. 5A-H are screenshots of example user interfaces that can be presented on a beverage cart driver's mobile computing device to deliver orders to golfers on a golf course. For example, the screenshots depicted in FIGS. 5A-H can be presented on mobile computing devices, for example, as part of a mobile application running on the mobile computing devices, such as the delivery mobile computing devices 106a-b, the mobile computing device 204, the mobile computing device 302, and/or other appropriate mobile computing devices. Although depicted for golf course implementations, the features depicted and described with regard to FIGS. 5A-H can be adapted and used in other implementations, such as events (e.g., sporting events, music concerts, festivals), restaurants/bars, and/or other appropriate contexts.

Referring to FIG. 5A, an example user interface 500 is depicted as presenting the status of orders for mobile delivery on a golf course. In a first section 502, open orders that have not yet been assigned to/selected by a delivery worker are presented. In this example, one order 504 is listed as having been placed from hole 2, pending for 5 minutes, and with no one handling the order. A selectable element 506 (e.g., button) is presented for the order 504 through which the user (delivery worker) can designate himself/herself to handle delivery of the order 504. Another selectable element 508 (e.g., button) is presented through which the user (delivery worker) can initiate communication with the golfer who placed the order, such as initiating a text messaging session, phone call, and/or video chat with the golfer.

A second section 510 identifies orders that have been assigned delivery workers and that are currently out for delivery, which includes example orders 512 and 514. The order 512 is identified as being for a golfer who is currently located on hole 13 at or near the 91-yard mark. The order 512 is currently being handled by delivery worker Alec and the order has been pending for 1 minute. The order 514 is identified as being for a golfer who is currently located on hole 4 at or near the 31-yard mark. The order 514 additionally indicates that delivery worker Eddie is handling the order (user to whom the interface 500 is presented) and that the order has been pending for 8 minutes. The color (or other visual effects) can be changed for icons 516a-d to indicate how long various orders have been pending. For example, an example color scheme can include green for orders pending less than 5 minutes, yellow for order pending between 5-10 minutes, and red for orders pending more than 10 minutes.

A selectable element 518 (e.g., button) can be presented for the order 512 that is being handled by another delivery worker (Alec) through which the user of the interface 500 (delivery worker Eddie) can take over handling of the order 512. If the element 518 is selected, the other delivery worker (delivery worker Alec) may be notified and/or have to consent to control being passed to the selecting user before the selecting user (delivery worker Eddie) takes over control of the order 512. Another selectable element 520 (e.g., button) is presented through which the user of the interface 500 can communicate with the golfer who placed the order 512 and/or with the other delivery worker (delivery worker Alec) delivering the order, such as through text messaging, phone calls, and/or video conferencing.

A selectable element 522 (e.g., button) can be presented for the order 514, which is being handled by the user of the user interface 500 (delivery worker Eddie), through which delivery of the order can be confirmed. For example, selection of the element 522 can cause a delivery confirmation to be transmitted from the delivery mobile computing device 106a to the computer system 104, as described above with regard to FIG. 1 and step O (170). A selectable element 524 (e.g., button) is also presented through which the user can initiate a communication session with the golfer who placed the order 514.

A third section 526 is also presented that includes orders that are being handled by the user of the user interface 500 (delivery worker Eddie). In this example, one order 528 is currently being handled by the user of the interface 500, which is the same as the order 514 described above.

In areas that do not include the described selectable elements, the orders 504, 512, 514, and 528 can be themselves selectable and can result in presentation of a menu of options that are available to the user for the orders, depending on the status of the order (e.g., open, assigned to the user, assigned to another user, delivered). Referring to FIG. 5B, an example menu of options 530 is presented in response to user selection of the order 514 (or the order 528, which is the same as order 514). The menu of options 530 includes selectable elements (e.g., buttons) through which the user can cancel the order (532a), indicate that the order has been delivered (532b), map the current location of the golfer who placed the order relative to the location of the user/mobile computing device presenting the interface 500 (532c), remove himself/herself as handling the order (532d) (which can place the order back in the first section 502 of open orders), can initiate a messaging session with the golfer who placed the order (532e), and can return to the interface 500 (532f).

Referring to FIG. 5C, a confirmation interface 534 can be presented after the user has selected either the selectable element 522 that indicates that the order 514 has been delivered or the selectable element 532b from the menu of options 530 for the order 514. The interface 534 can include a selectable element 536 (e.g., button) through which the user can confirm that delivery has been performed and another selectable element 538 (e.g., button) through which the earlier indication of delivery can be canceled (e.g., delivery button 522 originally pressed in error).

Referring to FIG. 5D, an example interface 540 through which the user (delivery worker Eddie) can communicate with a golfer, such as a golfer who placed an order, is presented. For example, the interface 540 can be presented in response to selection of the elements 508, 520, 524, and/or 532e. In the depicted example, the user (delivery worker Eddie) has entered a message to the golfer asking for the golfer's current location.

Referring to FIGS. 5E-H, example interfaces 542-548 are depicted showing a map that plots the locations of golfers (as indicated by the golfer icons) relative to the locations of beverage carts (as indicated by the golf cart icons) on the golf course. In the example interface 542, the three golfers are identified with a particular visual effect (e.g., color, shading, size) to indicate that each of the three golfers has an open order. In the example interface 544, three golfers are depicted as having open orders and a fourth golfer is depicted with an icon with another visual effect (e.g., color, shading, size) indicating that an order for the fourth golfer is currently being handled by a user of the interface 544 (e.g., delivery worker Eddie). In the example interface 546, three golfers are depicted with icons indicating that their orders are being handled by other delivery workers and an icon for the fourth golfer whose order is being handled by the user of the interface 546 is presented with an annotation (“my order” message) that may be presented in response to selection of the icon. In the example interface 548, an annotation (“someone else is delivering this” message) is presented for one of the other golfers whose order is being handled by another delivery worker.

The interfaces 542-548 can be continuously updated based on real-time (or near real-time) location information for both golfers and delivery workers through their associated mobile computing devices. The interfaces 542-548 may be presented in response to selection of the element 532c.

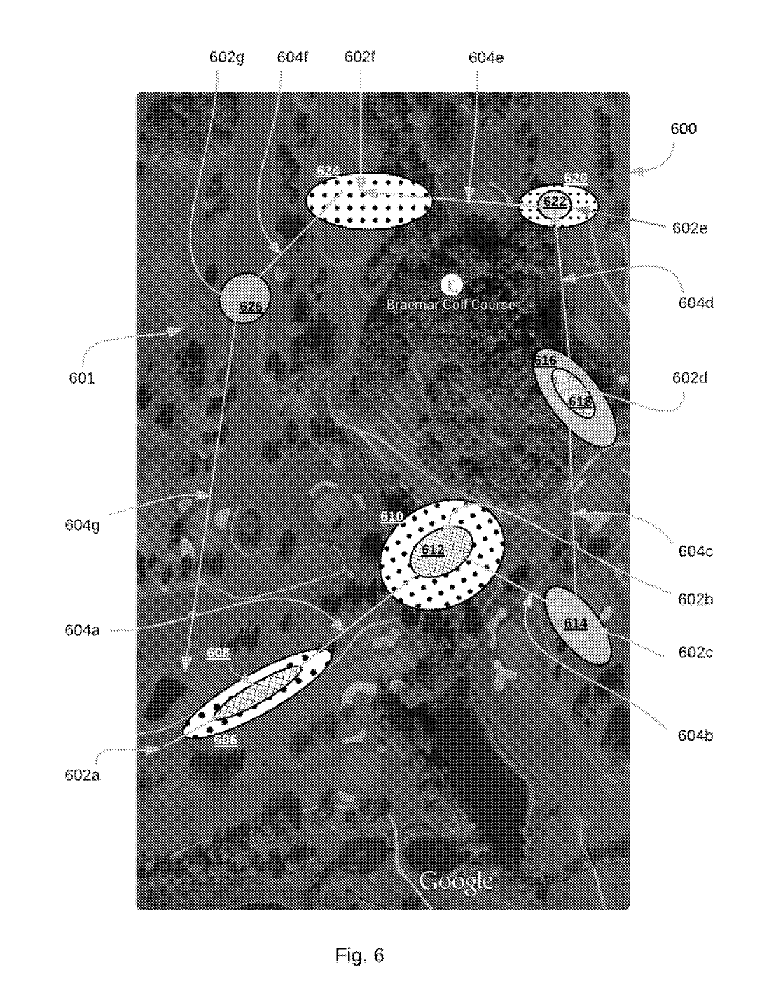

FIG. 6 is a screenshot of example user interface 600 that can be presented on a beverage cart driver's mobile computing device to provide route optimization information to the beverage cart driver. The example user interface 600 can be presented on any of a variety of appropriate mobile computing devices, such as the delivery mobile computing devices 106a-b described above with regard to FIG. 1, the mobile computing device 204 described above with regard to FIGS. 2A-F, the delivery mobile computing device 302 described above with regard to FIG. 3, and/or other mobile computing devices. The example user interface 600 can be presented in combination with the other user interfaces described above, such as the user interfaces 212, 328, 500, 534, 540-548, and/or other appropriate user interfaces.

In the example user interface 600, information identifying suggested routes and areas where orders are likely to be placed and/or fulfilled are depicted overlaid a map 601 of an example golf course (“Braemar Golf Course”). For instance, the interface 600 depicts suggested routes 604a-g for travelling a loop across locations 602a-g. An order for traveling across the locations 602a-g is indicated by the directionality and progress of the routes 604a-g. For instance, the interface 600 recommends that the user (e.g., golf cart driver) travel from location 602a along route 604a to location 602b, then along route 604b to location 602c, then along route 604c to location 602d, then along route 604d to location 602e, then along route 604e to location 602f, then along route 604f to location 602g, and then along route 604g and back to location 602a.

The user interface 600 also highlights areas 606-626 where orders are most likely to be placed by golfers on the golf course. The areas 606-626 that are depicted in this example are presented as a heat map, with areas having different levels of intensity (e.g., colors, shading, levels of transparency, text) that correspond to the probability of an order being placed and/or service being requested by a golfer within those areas. For example, the areas 608, 612, 618, and 622 are identified with diagonal lines and are intended to represent the areas with the greatest intensity/likelihood of being a location where orders are placed/service being requested by golfers on the golf course. Although not depicted in FIG. 6, which is grayscale, the areas 608, 612, 618, and 622 can be color coded (e.g., red color to indicate area of greatest intensity/likelihood).

Likewise, the areas 606, 610, 620, and 624, which are identified with dots, are intended to represent the areas on the golf course with an intermediate intensity/likelihood of being areas within which a golfer will place an order/request service. The areas 606, 610, 620, and 624 can be color coded as well (e.g., orange/yellow color to indicate intermediate intensity/likelihood). Similarly, the areas 614, 616, and 626, which are highlighted areas that do not include special graphical overlays, such as diagonal lines or dots, are intended to represent areas on the golf course with a lower intensity/likelihood of being areas within which a golfer will place an order/request service. Although the areas 614, 616, and 626 are identified as areas of lower intensity/likelihood, they can still correspond to areas within which there is a greater likelihood of an order being placed than areas that are not highlighted, such as the portion of the golf course along which the route 604g travels. The areas 614, 616, and 626 can also be color coded (e.g., green color to indicate areas of lower intensity/likelihood).

The areas 606-626 can be identified based on a variety of information, such as historical order information identifying locations where orders have been previously placed by golfers on the golf course, attributes of such orders (e.g., time of day, date, day of week, user who placed the order (e.g., golf course member, league participant, USGA member, non-member), rate of play at the time orders were placed (e.g., fast play—no waiting time at tees, slow play—many tees backed-up), weather conditions when orders were placed, season (e.g., fall, summer, spring), events going on when orders placed), items that were ordered (e.g., food items, beverages, basic service request), the current location of golfers on the course (e.g., based on locations reported from golfers' mobile computing devices), weather conditions, events that are ongoing (e.g., evening league play), and/or other appropriate factors.

For example, the areas 606-626 can be determined by selecting/filtering, from a data set that includes all historical orders for the golf course, a subset of the data that is appropriate given the current conditions when the user interface 600 is being presented and, based on that data subset, identifying the areas 606-626 where orders are more likely to occur. For instance, if the user interface 600 is being displayed to a golf cart work at 7:00 pm on a Thursday night, a subset of orders that were placed on Thursday evenings at or around 7:00 pm (e.g., within one hour before or after 7:00 pm—between 6:00 pm and 8:00 pm) can be selected and the areas 606-626 can be determined using such a subset. In a further example, if at that 7:00 pm time on Thursday there is also a league going on, the subset may be further filtered to include only orders that were placed on Thursday evenings at or around 7:00 pm while league play was going on. Such selection of subsets/filtering of the historical order information can provide a more accurate indication to a user of the interface 600 where and when orders are likely to be placed on the golf course.

Although not depicted, timing information can be factored into the routes 604a-g and order with which the user (golf cart driver) is directed to drive across the locations 602a-g so as to position the user at the locations 602a-g at the optimal times to catch and/or respond quickly to orders. For instance, instead of directing the user to travel from location 602a directly to 602c, the routes 604a and 604b can be suggested so that the user will arrive at the location 602c later than if the user had traveled there directly. Such timing can be based on a variety of factors, such as the current locations of golfers on the golf course, the current rate of play on the golf course, times since which the user or other golf cart drivers were at various locations, and/or other appropriate factors. Timing information and targets may also be presented to the user through the interface 600, such as identifying times when the user (golf cart driver) should try to arrive at each of the locations 602a-g and durations of time for which the user should wait at the locations 602a-g before progressing to the next location along the routes 604a-g.

As indicated by the routes 604a-g on the map 601, the routes 604a-g may not follow a sequential progression of holes on the golf course and instead may deviate from the sequential progression of the golf course (e.g., hole 1, hole 2, hole 3, etc.) in order to provide optimized paths for the user (golf cart driver) to maximize sales over a distance traveled and/or over a time period. For example, the golf cart can be direct by the routes 604a-g to travel from hole 4 to hole 7 and then back to hole 5.

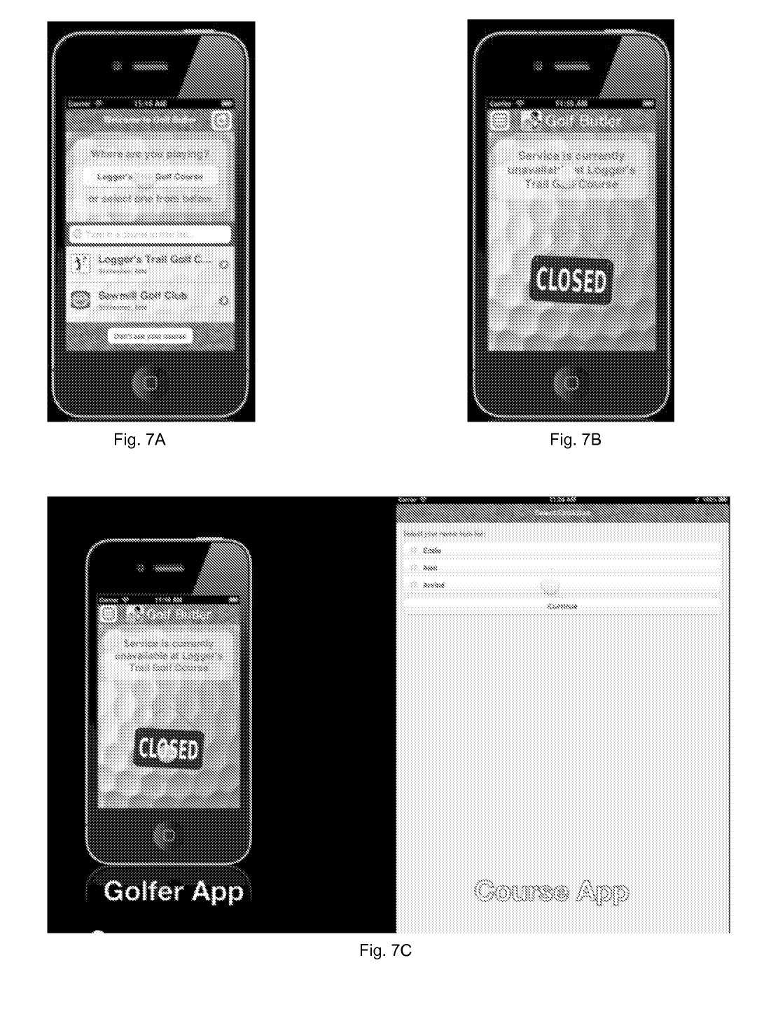

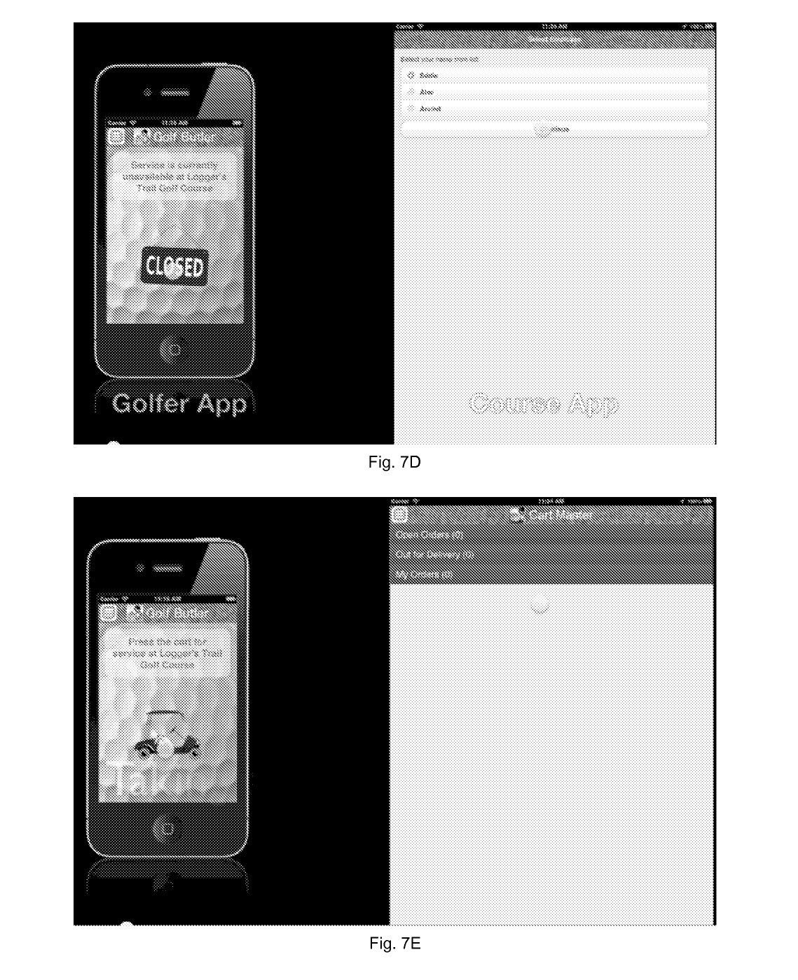

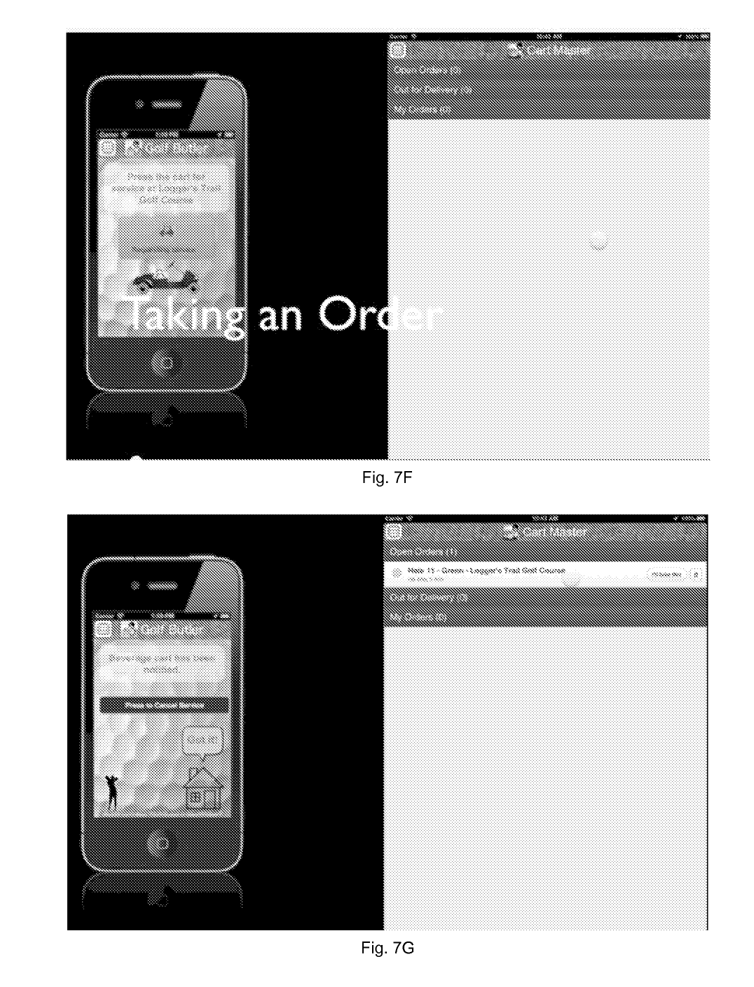

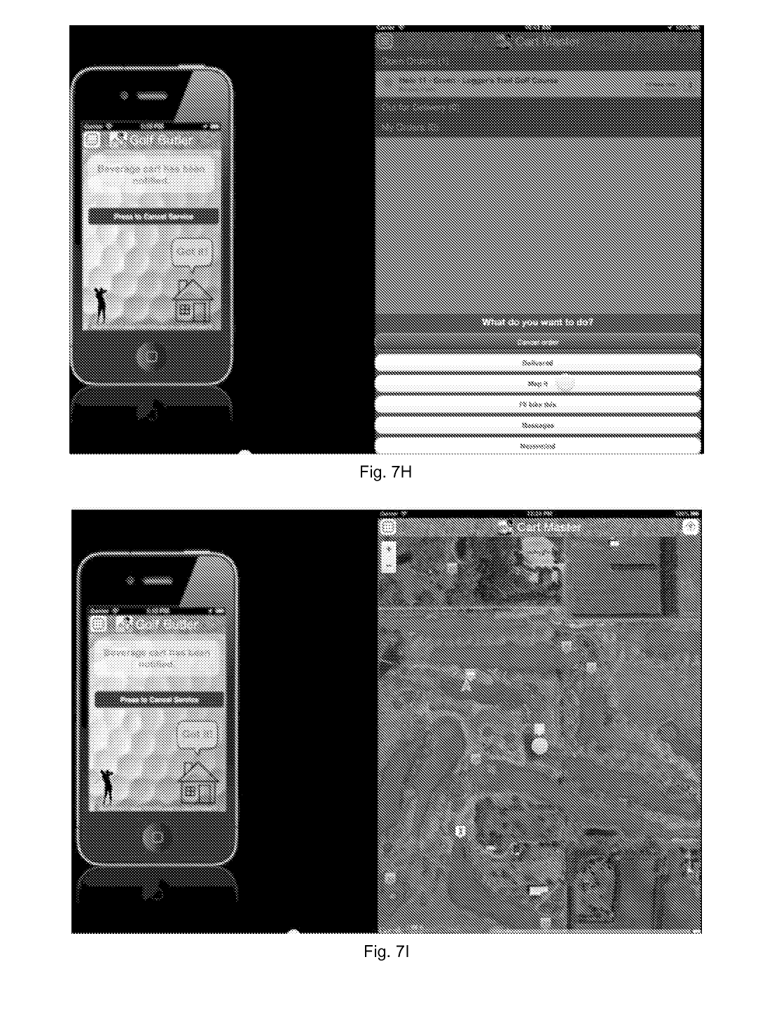

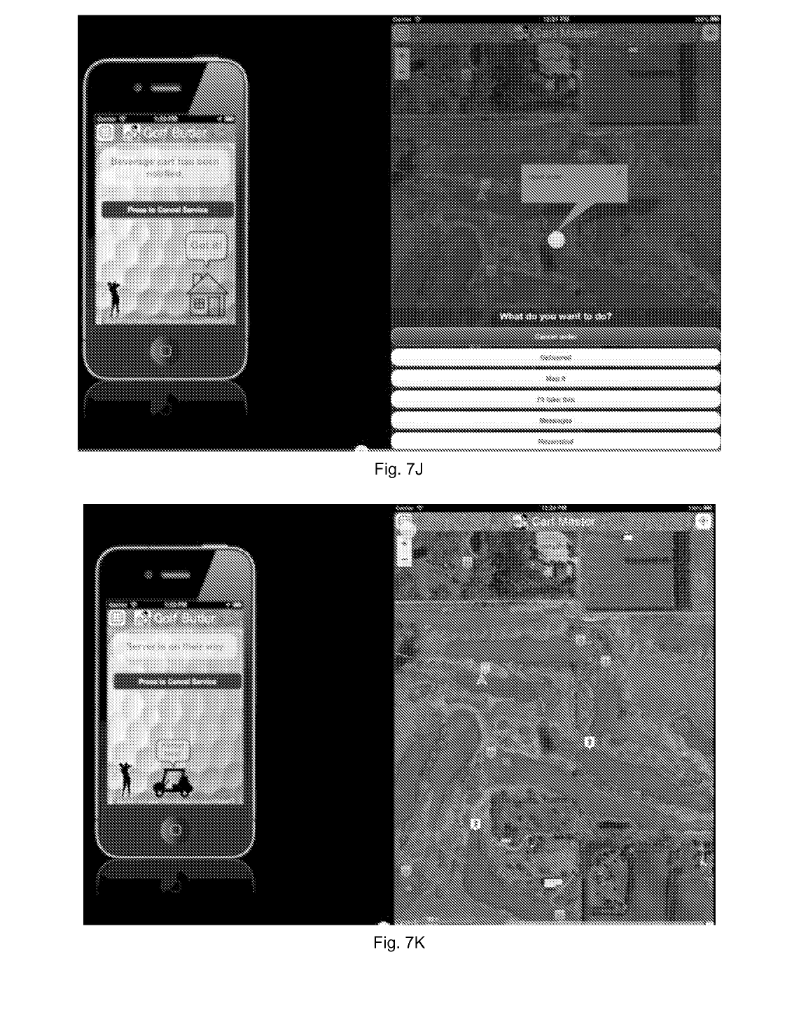

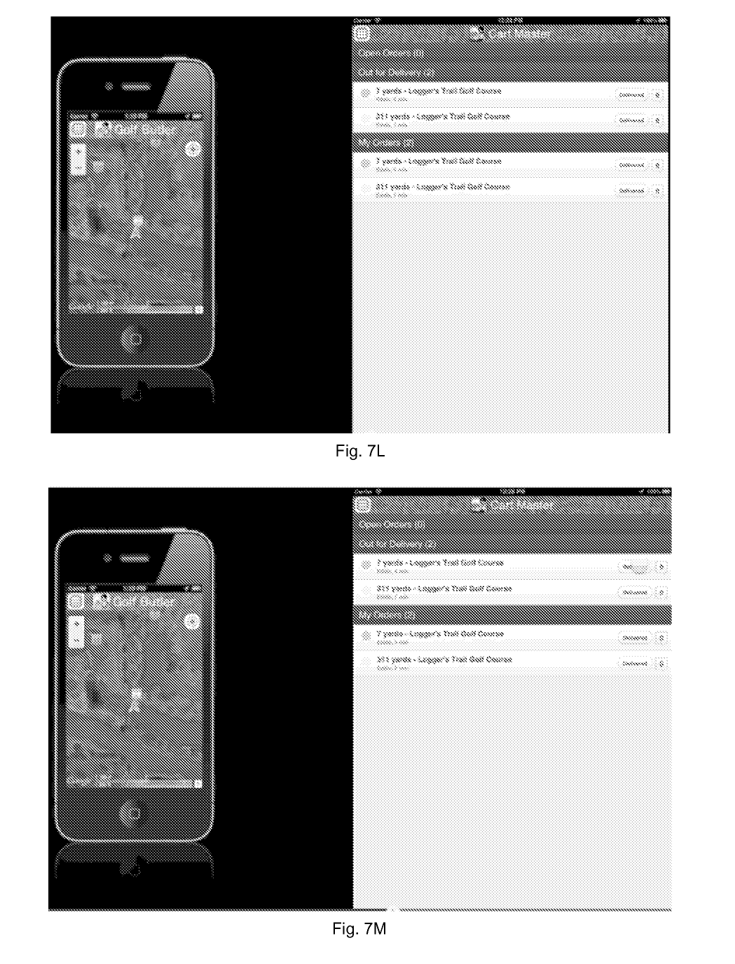

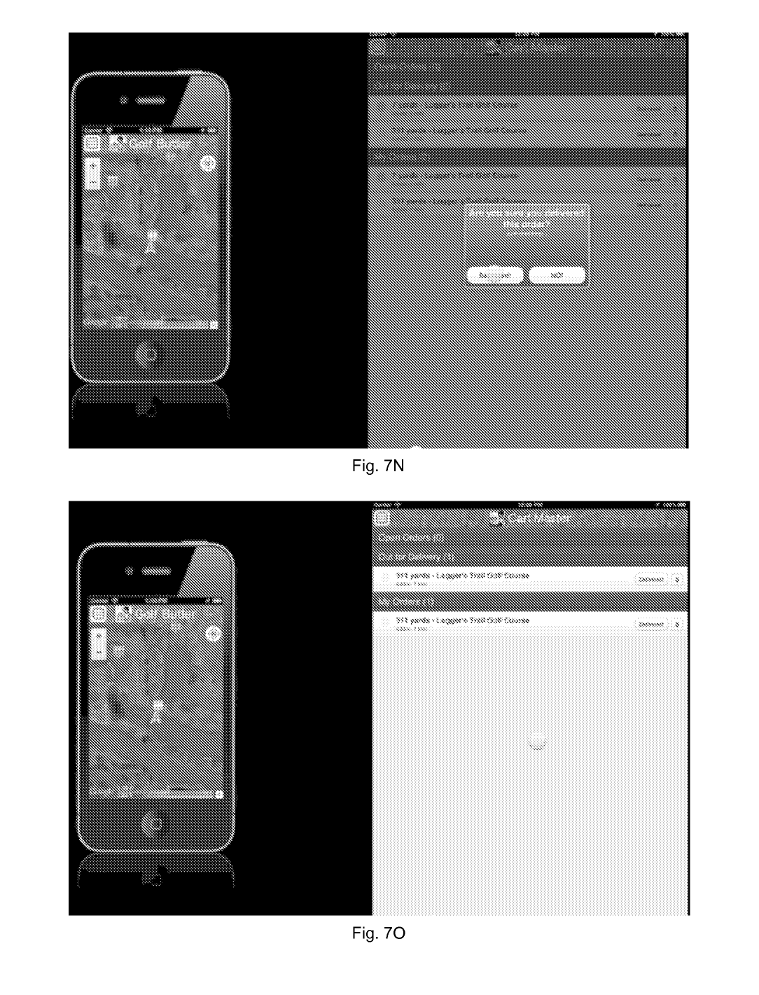

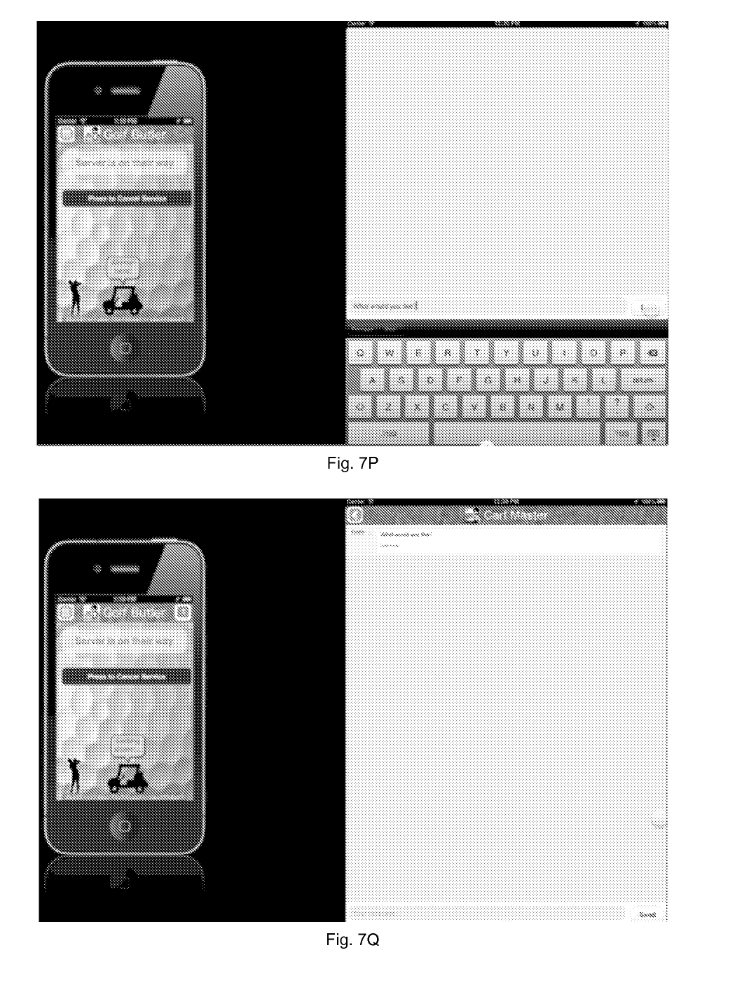

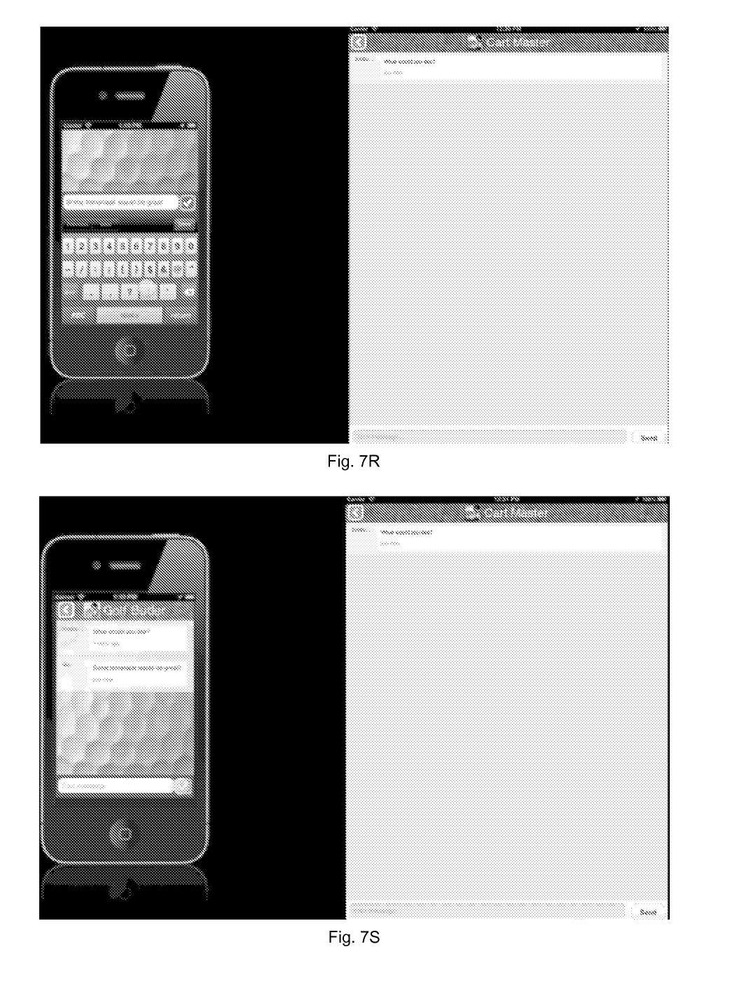

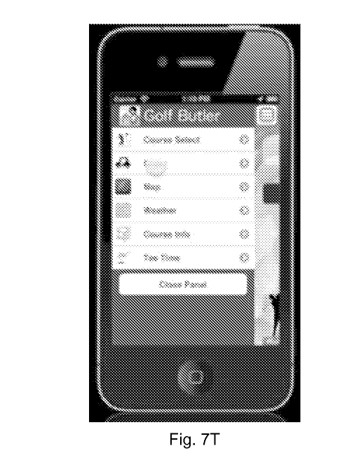

FIGS. 7A-T are screenshots of user interfaces on mobile computing devices through which orders can be placed and fulfilled. Through the depicted user interfaces, which can be presented on mobile computing devices running mobile applications, golfers can request service from the food and beverage cart with one press, and can be provided with their order status, a map of the golf course with the food and beverage cart positions, weather, tee time information, and more.

To start out, golfers can select the course they are playing, as depicted in FIG. 7A, and then they can be brought to an order page where they can request service, as depicted in FIG. 7B. The food and beverage cart employee can have a companion application that tracks the orders coming in from the golfers, as depicted in FIG. 7C. After the food and beverage cart employee logs into the companion application, the golfer's mobile application is open for business, as depicted in FIGS. 7D-E. To place an order with the food and beverage cart, the golfer simply presses the cart button, as depicted in FIG. 7F, and is informed about the status of their order, as depicted in FIG. 7G. The golfer's order information is displayed on the companion application, as also depicted in FIG. 7G. The food and beverage cart employee can select the item to bring up action items, which include delivering the order if the order has been completed, taking or owning the order which will take the order out of the “open orders” category and put the orders into the “my orders” category of the list view, messaging the golfer who placed the order, or map the order, as depicted in FIG. 7H.

Mapping the order allows the food and beverage cart employee to view all of the orders on the course with respect to their own position which is shown by the blue navigator icon, as depicted in FIG. 7I. The operator can plan an efficient route to hit all of the golfers requesting service. If the operator would like to take the order right from the map page, the action menu can be brought up by pressing the order icon, as depicted in FIGS. 7J-K.

The golfer can also view the food and beverage cart's progression on the map page, as depicted in FIG. 7L. Once the food and beverage cart employee meets the golfer and fulfills the request, the operator can complete the order from the action menu or from the quick button on the order item, as depicted in FIGS. 7M-O.

Another feature is messaging between the food and beverage cart employee and the golfer. The food and beverage cart employee can initiate the messaging by selecting the messaging option from the action menu or from the shortcut button on the order item in the companion application. The food and beverage cart employee then types a message to the golfer, as depicted in FIG. 7P, and the golfer application is notified of an incoming message with a push notification and a message bubble on the top right hand side of the screen, as depicted in FIG. 7Q. If the golfer presses the message bubble icon they are taken to the message page where they can respond to the food and beverage cart employee's message, as depicted in FIGS. 7R-S.

The golfer application also has other convenient features for golfers including seeing the local radar for those approaching rain clouds, get course contact information and location, and even make a tee time, as depicted in FIG. 7T. The golfer and companion applications can provide a golfer with better service and golfing experience out on the course, and can make serving food and beverage requests easy and more efficient for the food and beverage employees.

A variety of additional and/or alternative features can be used in combination with the computing devices, systems, and techniques described above. For example, delivery workers may be replaced with robotic devices that are capable, either remote control by humans or autonomously, of delivering goods and/or services to customers. For instance, delivery drones (e.g., land-based vehicles such as autonomous beverage carts, airborne vehicles such as quadcopters) could be used to deliver goods and services. The disclosed computing devices, systems, and techniques can be adapted to use such robotic delivery devices

In another example, the two or more delivery workers may fulfill portions of a customer's order. For instance, a first delivery worker may fulfill beverages and cold food items (e.g., candy, chips), and a second delivery worker may fulfill hot food items (e.g., hot dogs, hamburgers). The disclosed computing devices, systems, and techniques can be adapted to accommodate such configurations.

In another example, information identifying customers and/or delivery workers may be obtained and provided to appropriate other devices. For instance, when a customer places an order a photo using a camera on the customer's device (e.g., a camera phone) may be taken and transmitted to the delivery worker's device along with the customer's order so that the delivery worker can readily identify the customer. Similarly, a photo of the delivery worker may be provided to the customer's mobile device once the delivery worker has accepted/been assigned delivery of the customer's order. These features can allow for the customer and the delivery worker to readily identify each other, which can help facilitate delivery, especially in crowded spaces (e.g., stadiums, concerts, festivals).

In a further example, mobile computing devices that are used by delivery workers can include hardware components and/or software to accept and/or process electronic payments from customers, such as credit card payments. For instance, the mobile computing devices that are used by delivery workers can include magnetic strip readers for credit cards (e.g., SQUARE READER) and/or credit card readers that operate wirelessly, such as through near-field communication (NFC) (e.g., GOOGLE WALLET's NFC reader). The mobile computing devices may also be able to receive payment information through one or more wireless transmissions with a customer's mobile computing device, such as over a BLUETOOTH wireless connection with the customer's mobile computing device.

Computing devices and computer systems described in this document that may be used to implement the systems, techniques, machines, and/or apparatuses can operate as clients and/or servers, and can include one or more of a variety of appropriate computing devices, such as laptops, desktops, workstations, servers, blade servers, mainframes, mobile computing devices (e.g., PDAs, cellular telephones, smartphones, and/or other similar computing devices), computer storage devices (e.g., Universal Serial Bus (USB) flash drives, RFID storage devices, solid state hard drives, hard-disc storage devices), and/or other similar computing devices. For example, USB flash drives may store operating systems and other applications, and can include input/output components, such as wireless transmitters and/or USB connector that may be inserted into a USB port of another computing device.

Such computing devices may include one or more of the following components: processors, memory (e.g., random access memory (RAM) and/or other forms of volatile memory), storage devices (e.g., solid-state hard drive, hard disc drive, and/or other forms of non-volatile memory), high-speed interfaces connecting various components to each other (e.g., connecting one or more processors to memory and/or to high-speed expansion ports), and/or low speed interfaces connecting various components to each other (e.g., connecting one or more processors to a low speed bus and/or storage devices). Such components can be interconnected using various busses, and may be mounted across one or more motherboards that are communicatively connected to each other, or in other appropriate manners. In some implementations, computing devices can include pluralities of the components listed above, including a plurality of processors, a plurality of memories, a plurality of types of memories, a plurality of storage devices, and/or a plurality of buses. A plurality of computing devices can be connected to each other and can coordinate at least a portion of their computing resources to perform one or more operations, such as providing a multi-processor computer system, a computer server system, and/or a cloud-based computer system.

Processors can process instructions for execution within computing devices, including instructions stored in memory and/or on storage devices. Such processing of instructions can cause various operations to be performed, including causing visual, audible, and/or haptic information to be output by one or more input/output devices, such as a display that is configured to output graphical information, such as a graphical user interface (GUI). Processors can be implemented as a chipset of chips that include separate and/or multiple analog and digital processors. Processors may be implemented using any of a number of architectures, such as a CISC (Complex Instruction Set Computers) processor architecture, a RISC (Reduced Instruction Set Computer) processor architecture, and/or a MISC (Minimal Instruction Set Computer) processor architecture. Processors may provide, for example, coordination of other components computing devices, such as control of user interfaces, applications that are run by the devices, and wireless communication by the devices.

Memory can store information within computing devices, including instructions to be executed by one or more processors. Memory can include a volatile memory unit or units, such as synchronous RAM (e.g., double data rate synchronous dynamic random access memory (DDR SDRAM), DDR2 SDRAM, DDR3 SDRAM, DDR4 SDRAM), asynchronous RAM (e.g., fast page mode dynamic RAM (FPM DRAM), extended data out DRAM (EDO DRAM)), graphics RAM (e.g., graphics DDR4 (GDDR4), GDDR5). In some implementations, memory can include a non-volatile memory unit or units (e.g., flash memory). Memory can also be another form of computer-readable medium, such as magnetic and/or optical disks.

Storage devices can be capable of providing mass storage for computing devices and can include a computer-readable medium, such as a floppy disk device, a hard disk device, an optical disk device, a Microdrive, or a tape device, a flash memory or other similar solid state memory device, or an array of devices, including devices in a storage area network or other configurations. Computer program products can be tangibly embodied in an information carrier, such as memory, storage devices, cache memory within a processor, and/or other appropriate computer-readable medium. Computer program products may also contain instructions that, when executed by one or more computing devices, perform one or more methods or techniques, such as those described above.

High speed controllers can manage bandwidth-intensive operations for computing devices, while the low speed controllers can manage lower bandwidth-intensive operations. Such allocation of functions is exemplary only. In some implementations, a high-speed controller is coupled to memory, display 616 (e.g., through a graphics processor or accelerator), and to high-speed expansion ports, which may accept various expansion cards; and a low-speed controller is coupled to one or more storage devices and low-speed expansion ports, which may include various communication ports (e.g., USB, Bluetooth, Ethernet, wireless Ethernet) that may be coupled to one or more input/output devices, such as keyboards, pointing devices (e.g., mouse, touchpad, track ball), printers, scanners, copiers, digital cameras, microphones, displays, haptic devices, and/or networking devices such as switches and/or routers (e.g., through a network adapter).

Displays may include any of a variety of appropriate display devices, such as TFT (Thin-Film-Transistor Liquid Crystal Display) displays, OLED (Organic Light Emitting Diode) displays, touchscreen devices, presence sensing display devices, and/or other appropriate display technology. Displays can be coupled to appropriate circuitry for driving the displays to output graphical and other information to a user.

Expansion memory may also be provided and connected to computing devices through one or more expansion interfaces, which may include, for example, a SIMM (Single In Line Memory Module) card interfaces. Such expansion memory may provide extra storage space for computing devices and/or may store applications or other information that is accessible by computing devices. For example, expansion memory may include instructions to carry out and/or supplement the techniques described above, and/or may include secure information (e.g., expansion memory may include a security module and may be programmed with instructions that permit secure use on a computing device).

Computing devices may communicate wirelessly through one or more communication interfaces, which may include digital signal processing circuitry when appropriate. Communication interfaces may provide for communications under various modes or protocols, such as GSM voice calls, messaging protocols (e.g., SMS, EMS, or MMS messaging), CDMA, TDMA, PDC, WCDMA, CDMA2000, GPRS, 4G protocols (e.g., 4G LTE), and/or other appropriate protocols. Such communication may occur, for example, through one or more radio-frequency transceivers. In addition, short-range communication may occur, such as using a Bluetooth, Wi-Fi, or other such transceivers. In addition, a GPS (Global Positioning System) receiver module may provide additional navigation- and location-related wireless data to computing devices, which may be used as appropriate by applications running on computing devices.

Computing devices may also communicate audibly using one or more audio codecs, which may receive spoken information from a user and convert it to usable digital information. Such audio codecs may additionally generate audible sound for a user, such as through one or more speakers that are part of or connected to a computing device. Such sound may include sound from voice telephone calls, may include recorded sound (e.g., voice messages, music files, etc.), and may also include sound generated by applications operating on computing devices.

Various implementations of the systems, devices, and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) can include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., LCD display screen, LED display screen) for displaying information to users, a keyboard, and a pointing device (e.g., a mouse, a trackball, touchscreen) by which the user can provide input to the computer. Other kinds of devices can be used to provide for interaction with a user as well; for example, feedback provided to the user can be any form of sensory feedback (e.g., visual feedback, auditory feedback, and/or tactile feedback); and input from the user can be received in any form, including acoustic, speech, and/or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

The above description provides examples of some implementations. Other implementations that are not explicitly described above are also possible, such as implementations based on modifications and/or variations of the features described above. For example, the techniques described above may be implemented in different orders, with the inclusion of one or more additional steps, and/or with the exclusion of one or more of the identified steps. Additionally, the steps and techniques described above as being performed by some computing devices and/or systems may alternatively, or additionally, be performed by other computing devices and/or systems that are described above or other computing devices and/or systems that are not explicitly described. Similarly, the systems, devices, and apparatuses may include one or more additional features, may exclude one or more of the identified features, and/or include the identified features combined in a different way than presented above. Features that are described as singular may be implemented as a plurality of such features. Likewise, features that are described as a plurality may be implemented as singular instances of such features. The drawings are intended to be illustrative and may not precisely depict some implementations. Variations in sizing, placement, shapes, angles, and/or the positioning of features relative to each other are possible.

What is claimed is:

1. A computer-implemented method comprising:
receiving, at a mobile computing device and after transmitting an order, information that identifies a delivery worker who is handling delivery of the order;
continuously updating an interface presented by the mobile computing device until the order has been delivered, the interface identifying a current location of the delivery worker relative to a current location of the mobile computing device as both of the current locations change over time, the continuously updating comprising:
determining, by the mobile computing device, the current location of the mobile computing device;
receiving, at the mobile computing device, the current location of the delivery worker; and
presenting, by the mobile computing device, the interface depicting the current location of the delivery worker relative to the current location of the mobile computing device.

2. The computer-implemented method of claim 1, further comprising:
determining a current level of progress of delivery of the order by the delivery worker based, at least in part, on a comparison of a current distance between the delivery worker and the mobile computing device with a starting distance between the delivery worker and the mobile computing device when delivery of the order started;
presenting, by the mobile computing device, information describing the current level of progress.

3. The computer-implemented method of claim 2, wherein the information describing the current level of progress comprises a scale with the mobile computing device at one end and a position of the order when delivery of the order started, with an icon corresponding to the delivery worker being presented at an appropriate location along the scale.

4. The computer-implemented method of claim 2, wherein the information comprises textual information that identifies a time, distance, or percentage of the delivery process remaining.

5. The computer-implemented method of claim 2, wherein the current distance and the starting distance comprise distances along one or more paths.

6. The computer-implemented method of claim 2, wherein the current distance and the starting distance comprise overhead distances.

7. The computer-implemented method of claim 1, wherein the interface comprises a graphical user interface that depicts the locations of a plurality of delivery workers and that highlights a graphical element corresponding to the delivery worker handling delivery of the order.

8. The computer-implemented method of claim 1, further comprising:
automatically presenting, in response to receiving the information that identifies the delivery worker as handling delivery of the order, a notification on the mobile computing device that indicates that the delivery worker is handling delivery of the order.

9. The computer-implemented method of claim 1, wherein the mobile computing device is associated with a golfer on a golf course, the delivery worker is a beverage cart driver on the golf course, and the current locations of the mobile computing device and the delivery worker are determined to be human-readable locations on the golf course.

10. A computer-implemented method comprising:
accessing, by a computer system, historical order information that describes locations at which orders were placed across a particular geographic area;
identifying, by the computer system based, at least in part, on the historical order information, one or more locations within the particular geographic area where orders have at least a threshold likelihood of being placed within a threshold period of time; and
transmitting, to one or more computing devices associated with delivery workers who handle fulfillment of orders within the particular geographic area, the determined one or more locations.

11. The computer-implemented method of claim 10, wherein the particular geographic area comprises a particular golf course.

12. The computer-implemented method of claim 10, wherein the determined one or more locations are transmitted to the one or more computing devices as heatmaps.

13. The computer-implemented method of claim 10, wherein the one or more locations are identified further based on information that describes one or more current locations of users within the particular geographic area.

14. A computer-implemented method comprising:
presenting, by a mobile computing device that is associated with a delivery worker, information that identifies an order that is open and a selectable feature through which the delivery worker can accept responsibility for delivering at least a portion of the order;
receiving, at the mobile computing device, user input selecting the selectable feature;
continuously updating, in response to receiving the user input, an interface presented by the mobile computing device until the order has been delivered, the interface identifying a current location of a customer who placed the order relative to a current location of the mobile computing device as both of the current locations change over time, the continuously updating comprising:
determining, by the mobile computing device, the current location of the mobile computing device;
receiving, at the mobile computing device, the current location of the customer; and
presenting, by the mobile computing device, the interface depicting the current location of the customer relative to the current location of the mobile computing device.

15. The computer-implemented method of claim 14, wherein the interface comprises a graphical user interface that depicts locations of a plurality of customers and that highlights a graphical element corresponding to the customer who placed the order.

16. The computer-implemented method of claim 15, wherein the graphical user interface further depicts locations of a plurality of other delivery workers relative to the locations of the mobile computing device and the customer.

17. The computer-implemented method of claim 15, wherein graphical elements corresponding to the plurality of customers are selectable;
the method further comprising:
receiving input selecting one of the graphical elements corresponding to another customer whose order is being handled by another delivery worker; and
transmitting, to one or more other computing devices, information that indicates the delivery worker is taking over responsibility for delivering an order for the other customer, the transmitting causing the other delivery worker and the other customer to be notified of the delivery worker taking over responsibility.

18. The computer-implemented method of claim 14, wherein the customer is a golfer on a golf course, the delivery worker is a beverage cart driver on the golf course, and the current locations of the mobile computing device and the customer are determined to be human-readable locations on the golf course.

19. The computer-implemented method of claim 14, further comprising:
determining a current level of progress of delivery of the order by the delivery worker based, at least in part, on a comparison of a current distance between the customer and the mobile computing device with a starting distance between the customer and the mobile computing device when delivery of the order started;
presenting, by the mobile computing device, information describing the current level of progress.

20. The computer-implemented method of claim 19, wherein the information describing the current level of progress comprises a scale with the customer at one end and a position of the order when delivery of the order started, with an icon corresponding to the delivery worker being presented at an appropriate location along the scale.

21. The computer-implemented method of claim 19, wherein the information comprises textual information that identifies a time, distance, or percentage of the delivery process remaining.

22. The computer-implemented method of claim 19, wherein the current distance and the starting distance comprise distances along one or more paths.

23. The computer-implemented method of claim 19, wherein the current distance and the starting distance comprise overhead distances.
